(19) United States
(12) Patent Application Publication
(10) Pub. No.: US 2026/0231024 A1
(43) Pub. Date: Aug. 6, 2026

(54) CONFIGURATIONS FOR WAKE-UP SIGNALS WITH DISCONTINUOUS RECEPTION

(71) Applicant: QUALCOMM Incorporated, San Diego, CA (US)

(72) Inventors: Jung Ho RYU, Englewood Cliffs, NJ (US); Kazuki TAKEDA, Minato-ku (JP); Igor GUTMAN, Hod HaSharon (IL)

(21) Appl. No.: 19/046,848

(22) Filed: Feb. 6, 2025

(51) Int. Cl. H04W 52/02; H04W 76/28

(52) U.S. Cl. CPC H04W 52/0235; H04W 76/28

(57) ABSTRACT

In some examples of the techniques described herein, the latency of connected mode discontinuous reception (C-DRX) may be reduced by utilizing a low power wake-up signal (LP-WUS). For instance, physical downlink control channel (PDCCH) monitoring may be triggered based on the LP-WUS with the C-DRX configuration as a power saving procedure for a radio resource control (RRC) connected mode. In some approaches, the cycles of the additional PDCCH monitoring triggered by LP-WUS may be coordinated with C-DRX cycles. For example, an LP-WUS PDCCH monitoring cycle may evenly divide the C-DRX cycle. Utilizing the even division may allow, in one or more C-DRX cycles, a UE to perform a radio resource management (RRM) measurement in one or more time durations in which UE does not monitor the PDCCH. For instance, the RRM measurement procedure may be improved by reducing complexity of time durations in which RRM measurement may be performed.

### FIELD OF TECHNOLOGY

The following relates to wireless communications, including configurations for wake-up signals with discontinuous reception.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include receiving, from a network entity, configuration information indicating a configuration of the UE to perform physical downlink control channel (PDCCH) monitoring during an inactive portion of a connected mode discontinuous reception (C-DRX) period, the PDCCH monitoring triggered based on a wake-up signal received via a first radio component of the UE that consumes less operating power than a second radio component of the UE and receiving, from the network entity, a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

A UE is described. The UE may include one or more memories storing processor executable code, and one or more processors coupled with the one or more memories. The one or more processors may individually or collectively be operable to execute the code to cause the UE to receive, from a network entity, configuration information indicating a configuration of the UE to perform PDCCH monitoring during an inactive portion of a C-DRX period, the PDCCH monitoring triggered based on a wake-up signal received via a first radio component of the UE that consumes less operating power than a second radio component of the UE and receive, from the network entity, a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

Another UE is described. The UE may include means for receiving, from a network entity, configuration information indicating a configuration of the UE to perform PDCCH monitoring during an inactive portion of a C-DRX period, the PDCCH monitoring triggered based on a wake-up signal received via a first radio component of the UE that consumes less operating power than a second radio component of the UE and means for receiving, from the network entity, a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

A non-transitory computer-readable medium storing code is described. The code may include instructions executable by one or more processors to receive, from a network entity, configuration information indicating a configuration of the UE to perform PDCCH monitoring during an inactive portion of a C-DRX period, the PDCCH monitoring triggered based on a wake-up signal received via a first radio component of the UE that consumes less operating power than a second radio component of the UE and receive, from the network entity, a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

Some examples of the method, UEs, and non-transitory computer-readable medium described herein may further include operations, features, means, or instructions for receiving, via the first radio component, the wake-up signal during the inactive portion of the C-DRX period, the PDCCH monitoring triggered based on the wake-up signal received during the inactive portion of the C-DRX period.

Some examples of the method, UEs, and non-transitory computer-readable medium described herein may further include operations, features, means, or instructions for receiving, from the network entity, an indication of a periodicity and a first offset, where the wake-up signal monitoring occasion may be based on the periodicity and the first offset, and where the PDCCH monitoring occasion may be based on the wake-up signal monitoring occasion.

In some examples of the method, UEs, and non-transitory computer-readable medium described herein, a start of the PDCCH monitoring occasion may be based on a second offset from an end of the wake-up signal that may be transmitted during the wake-up signal monitoring occasion, from an end of a slot in which the wake-up signal may be transmitted, or from an end of a window for multiple wake-up signals.

Some examples of the method, UEs, and non-transitory computer-readable medium described herein may further include operations, features, means, or instructions for receiving, from the network entity, an indication of a periodicity and a first offset, where the PDCCH monitoring occasion may be based on the periodicity and the first offset, and where the wake-up signal monitoring occasion may be based on the PDCCH monitoring occasion.

Some examples of the method, UEs, and non-transitory computer-readable medium described herein may further include operations, features, means, or instructions for receiving, from the network entity, an indication of a second offset, where the wake-up signal monitoring occasion may be based on the second offset from the PDCCH monitoring occasion.

In some examples of the method, UEs, and non-transitory computer-readable medium described herein, a first subframe offset for an active portion of the C-DRX period may be equal to a second subframe offset for the PDCCH monitoring occasion or a first slot offset for the active portion of the C-DRX period may be equal to a second slot offset for the PDCCH monitoring occasion.

In some examples of the method, UEs, and non-transitory computer-readable medium described herein, a first subframe offset for an active portion of the C-DRX period may be equal to a second subframe offset for the wake-up signal monitoring occasion or a first slot offset for the active portion of the C-DRX period may be equal to a second slot offset for the wake-up signal monitoring occasion.

Some examples of the method, UEs, and non-transitory computer-readable medium described herein may further include operations, features, means, or instructions for receiving, from the network entity, an indication of the integer multiple, where the first period of the PDCCH monitoring occasion or the second period of the wake-up signal monitoring occasion may be based on the integer multiple.

In some examples of the method, UEs, and non-transitory computer-readable medium described herein, the first period of the PDCCH monitoring occasion or the second period of the wake-up signal monitoring occasion may be based on dividing the C-DRX period by the integer multiple.

A method by a network entity is described. The method may include outputting configuration information indicating a configuration to perform PDCCH monitoring during an inactive portion of a C-DRX period, the PDCCH monitoring triggered based on a wake-up signal and outputting a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

A network entity is described. The network entity may include one or more memories storing processor executable code, and one or more processors coupled with the one or more memories. The one or more processors may individually or collectively be operable to execute the code to cause the network entity to output configuration information indicating a configuration to perform PDCCH monitoring during an inactive portion of a C-DRX period, the PDCCH monitoring triggered based on a wake-up signal and output a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

Another network entity is described. The network entity may include means for outputting configuration information indicating a configuration to perform PDCCH monitoring during an inactive portion of a C-DRX period, the PDCCH monitoring triggered based on a wake-up signal and means for outputting a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

A non-transitory computer-readable medium storing code is described. The code may include instructions executable by one or more processors to output configuration information indicating a configuration to perform PDCCH monitoring during an inactive portion of a C-DRX period, the PDCCH monitoring triggered based on a wake-up signal and output a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

Some examples of the method, network entities, and non-transitory computer-readable medium described herein may further include operations, features, means, or instructions for outputting the wake-up signal during the inactive portion of the C-DRX period to trigger the PDCCH monitoring.

Some examples of the method, network entities, and non-transitory computer-readable medium described herein may further include operations, features, means, or instructions for outputting an indication of a periodicity and a first offset, where the wake-up signal monitoring occasion may be based on the periodicity and the first offset, and where the PDCCH monitoring occasion may be based on the wake-up signal monitoring occasion.

In some examples of the method, network entities, and non-transitory computer-readable medium described herein, a start of the PDCCH monitoring occasion may be based on a second offset from an end of the wake-up signal that may be transmitted during the wake-up signal monitoring occasion, from an end of a slot in which the wake-up signal may be transmitted, or from an end of a window for multiple wake-up signals.

Some examples of the method, network entities, and non-transitory computer-readable medium described herein may further include operations, features, means, or instructions for outputting an indication of a periodicity and a first offset, where the PDCCH monitoring occasion may be based on the periodicity and the first offset, and where the wake-up signal monitoring occasion may be based on the PDCCH monitoring occasion.

Some examples of the method, network entities, and non-transitory computer-readable medium described herein may further include operations, features, means, or instructions for outputting an indication of a second offset, where the wake-up signal monitoring occasion may be based on the second offset from the PDCCH monitoring occasion.

In some examples of the method, network entities, and non-transitory computer-readable medium described herein, a first subframe offset for an active portion of the C-DRX period may be equal to a second subframe offset for the PDCCH monitoring occasion or a first slot offset for the active portion of the C-DRX period may be equal to a second slot offset for the PDCCH monitoring occasion.

In some examples of the method, network entities, and non-transitory computer-readable medium described herein, a first subframe offset for an active portion of the C-DRX period may be equal to a second subframe offset for the wake-up signal monitoring occasion or a first slot offset for the active portion of the C-DRX period may be equal to a second slot offset for the wake-up signal monitoring occasion.

Some examples of the method, network entities, and non-transitory computer-readable medium described herein may further include operations, features, means, or instructions for outputting an indication of the integer multiple, where the first period of the PDCCH monitoring occasion or the second period of the wake-up signal monitoring occasion may be based on the integer multiple.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports configurations for wake-up signals with discontinuous reception in accordance with one or more aspects of the present disclosure.

FIG. 2 shows an example of a network architecture that supports configurations for wake-up signals with discontinuous reception in accordance with one or more aspects of the present disclosure.

FIG. 3 shows an example of a wireless communications system that supports configurations for wake-up signals with discontinuous reception in accordance with one or more aspects of the present disclosure.

FIG. 4 shows an example of a timing diagram that supports configurations for wake-up signals with discontinuous reception in accordance with one or more aspects of the present disclosure.

FIG. 5 shows an example of a timing diagram that supports configurations for wake-up signals with discontinuous reception in accordance with one or more aspects of the present disclosure.

FIG. 6 shows an example of a timing diagram that supports configurations for wake-up signals with discontinuous reception in accordance with one or more aspects of the present disclosure.

FIG. 7 shows an example of a timing diagram that supports configurations for wake-up signals with discontinuous reception in accordance with one or more aspects of the present disclosure.

FIG. 8 shows an example of a process flow that supports configurations for wake-up signals with discontinuous reception in accordance with one or more aspects of the present disclosure.

FIGS. 9 and 10 show block diagrams of devices that support configurations for wake-up signals with discontinuous reception in accordance with one or more aspects of the present disclosure.

FIG. 11 shows a block diagram of a communications manager that supports configurations for wake-up signals with discontinuous reception in accordance with one or more aspects of the present disclosure.

FIG. 12 shows a diagram of a system including a device that supports configurations for wake-up signals with discontinuous reception in accordance with one or more aspects of the present disclosure.

FIGS. 13 and 14 show block diagrams of devices that support configurations for wake-up signals with discontinuous reception in accordance with one or more aspects of the present disclosure.

FIG. 15 shows a block diagram of a communications manager that supports configurations for wake-up signals with discontinuous reception in accordance with one or more aspects of the present disclosure.

FIG. 16 shows a diagram of a system including a device that supports configurations for wake-up signals with discontinuous reception in accordance with one or more aspects of the present disclosure.

FIGS. 17 through 20 show flowcharts illustrating methods that support configurations for wake-up signals with discontinuous reception in accordance with one or more aspects of the present disclosure.

### DETAILED DESCRIPTION

Some wireless communications systems may include user equipments (UEs) with multiple radio components. For example, a UE may be equipped with a type of receiver (e.g., low power wake up receiver or radio (LP-WUR)) in addition to another receiver (e.g., a main receiver or radio (MR)) utilized for more complex communications. The LP-WUR may be utilized for receiving a wake-up signal (WUS) (e.g., a low power-wake up signal (LP-WUS)) to trigger physical downlink control channel (PDCCH) monitoring.

Connected mode discontinuous reception (C-DRX) may be a power saving procedure in which a UE may periodically wake up to monitor a PDCCH for a control message from the network. One or more periods when the UE wakes up to monitor the PDCCH for the control message from the network may be referred to as an active portion of a C-DRX period, where the C-DRX period may include the active portion and an inactive portion. During the inactive portion (e.g., when the UE is not in the active portion for monitoring PDCCH), the UE may enter a sleep state. During the inactive portion (e.g., during off durations), the network may not transmit, or the UE may not receive, control information, which may result in increased latency.

In some examples of the techniques described herein, the latency of C-DRX may be reduced by utilizing the LP-WUS. For instance, PDCCH monitoring may be triggered based on the LP-WUS with the C-DRX configuration as a power saving procedure for radio resource control (RRC) connected mode. In some approaches, the cycles of the additional PDCCH monitoring triggered by LP-WUS may be coordinated with C-DRX cycles. For example, an LP-WUS PDCCH monitoring cycle may evenly divide the C-DRX cycle. Utilizing the even division may allow, in one or more C-DRX cycles, a UE to perform a radio resource management (RRM) measurement in one or more time durations in which UE does not monitor the PDCCH (e.g., in cyclical time durations, periodic time durations, or time durations that are the same in multiple cycles). For instance, the RRM measurement procedure may be improved by reducing complexity of time durations in which RRM measurement may be performed.

Aspects of the disclosure are described in the context of wireless communications systems. Aspects of the disclosure are also described in the context of a network architecture, timing diagrams, and a process flow. Aspects of the disclosure are further illustrated by and described with reference to apparatus diagrams, system diagrams, and flowcharts that relate to configurations for wake-up signals with discontinuous reception.

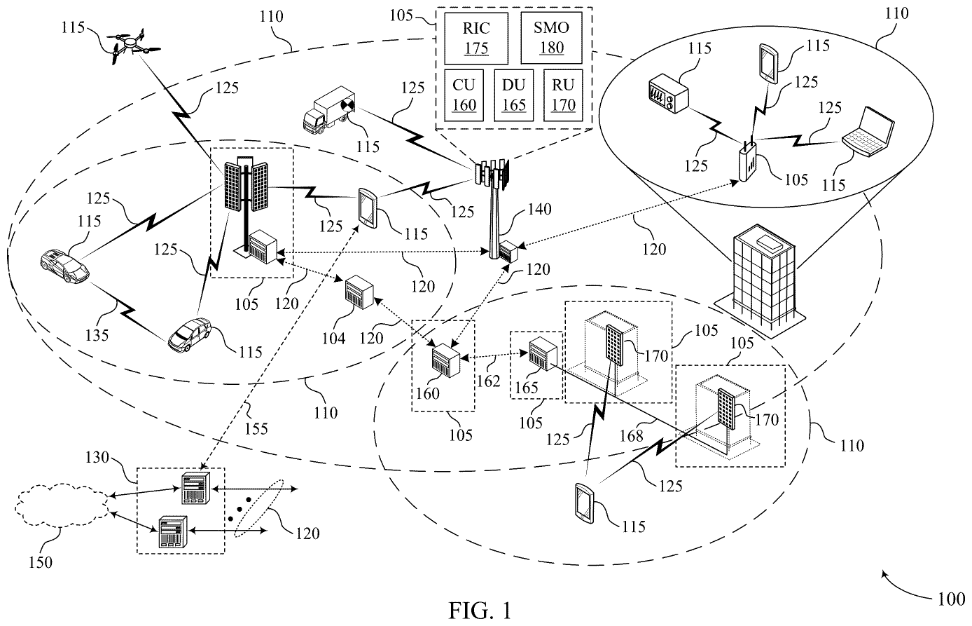

FIG. 1 shows an example of a wireless communications system 100 that supports configurations for wake-up signals with discontinuous reception in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support configurations for wake-up signals with discontinuous reception as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems may include UEs 115 with multiple radio components. For example, a UE 115 may be equipped with a type of receiver (e.g., LP-WUR) in addition to another receiver (e.g., an MR) utilized for more complex communications. The LP-WUR may be utilized for receiving a WUS (e.g., an LP-WUS) to trigger PDCCH monitoring.

In some approaches, a UE 115 may support OOK-1 or OOK-4 for an LP-WUS or a low power synchronization signal (LP-SS). In baseband, an OOK waveform may be a sequence of relatively higher power or amplitude (e.g., “on”) durations or relatively lower (or zero) power or amplitude (e.g., “off”) durations. For instance, an OOK waveform may vary between two states, where a first state (e.g., a high or “on” duration) may have a higher power or amplitude than a second state (e.g., a low or “off” duration). A high or low duration may be utilized to convey an information bit. For instance, a transition from a low (e.g., “off”) duration to a high (e.g., “on”) duration may be utilized to convey an information bit (e.g., 1 or 0), or a transition from a high (e.g., “on”) duration to a low (e.g., “off”) duration may be utilized to convey an information bit (e.g., 0 or 1). In OOK-1, 1 bit of information may be conveyed in one OFDM symbol (e.g., using amplitude of an OOK-1 waveform).

In OOK-4, M bits of information may be conveyed in one OFDM symbol (e.g., using amplitude of an OOK-4 waveform). For instance, two durations may be utilized in OOK-4 with M=2, where the two durations may occur in one OFDM symbol period (e.g., 2 OOK symbols per OFDM symbol). Four durations may be utilized in OOK-4 with M=4, where the four durations may occur in one OFDM symbol period (e.g., 4 OOK symbols per OFDM symbol).

In some examples, one or more portions (e.g., “on” durations) may be overlaid with another signal or OFDM sequence. For instance, an overlaid OFDM sequence may be Gold sequence, M sequence, computer searched sequence, or Zadoff-Chu sequence. Eleven physical resource blocks (PRBs) may be utilized to communicate (e.g., transmit or receive) an LP-WUS with a subcarrier spacing (SCS) of 30 kilohertz (kHz) for frequency range 1 (FR1). A similar or different quantity of PRBs may be utilized for an LP-WUS in frequency range 2 (FR2).

In some approaches, the LP-WUR may be switched on and off relatively quickly, or may be capable of receiving and processing relatively simple signals (e.g., with a limited bandwidth or a relatively simple waveform). The LP-WUR may consume significantly less power to operate than the MR. In some cases, the LP-WUR may not transmit signals. In some aspects, the LP-WUS may be an on-off keying (OOK) waveform, and the UE 115 may use an LP-WUR to receive the LP-WUS. For LP-WUS triggered PDCCH monitoring, the UE 115 may switch off the MR to conserve power (e.g., the UE 115 may enter a power-conserving state, a reduced activity state, or a “deep sleep” mode). With the MR off, the UE 115 may utilize the LP-WUR to monitor for the LP-WUS. If the network transmits an LP-WUS and the UE 115 receives the LP-WUS, the UE 115 may activate (e.g., may wake up or switch on) the MR and may receive a control message from the network (e.g., via LP-WUS triggered PDCCH monitoring) using the MR.

C-DRX may be a power saving procedure in which a UE 115 may periodically wake up to monitor a PDCCH for a control message from the network (e.g., a network entity 105). One or more periods when the UE 115 wakes up to monitor the PDCCH for the control message from the network may be referred to as an active portion (or “active time”) of a C-DRX period (or “DRX cycle”), where the C-DRX period may include the active portion and an inactive portion. The C-DRX period or DRX cycle may start at the beginning of a subframe or with an offset (e.g., drx-SlotOffset) from the beginning of the subframe. A starting subframe of the C-DRX period or DRX cycle may be determined based on a configuration parameter (e.g., drx-LongCycleStartOffset).

A UE 115 may monitor a PDCCH on a serving cell during the active portion (or active time). The active portion may include a first duration (e.g., a time while drx-onDurationTimer is running) or a second duration (e.g., a time while drx-InactivityTimer configured for a DRX group is running), where the first duration and the second duration may overlap. During the first duration, for example, the UE 115 may monitor a PDCCH to determine whether a transmission is scheduled or will occur for the UE 115. The second duration (e.g., drx-InactivityTimer) may begin from the reception of the PDCCH (e.g., at the end of the PDCCH) and may continue while the drx-InactivityTimer is running. For instance, the second duration may begin during the first duration and may extend after the first duration (e.g., after the expiration of the drx-onDurationTimer) while the drx-InactivityTimer is running.

In some examples, a UE 115 may be configured with downlink control information power saving (DCP) functionality. The UE 115 may search for a DCP message starting at an offset (e.g., ps-Offset-r16) before the start of the active period (e.g., before the start of the drx-OnDurationTimer). The DCP message may be transmitted in downlink control information (DCI) and may be utilized to activate or wake up a UE 115. It should be noted that the DCP message may be received (e.g., may only be received) by an MR (e.g., not by an LP-WUR). The ps-Offset-r16 may indicate the start of a search time of DCI format 2-6 with cyclic redundancy check (CRC) scrambled by a radio network temporary identifier (RNTI) (e.g., a PS-RNTI) relative to the start of the drx-onDurationTimer of long DRX. The ps-Offset-r16 may have a value in multiples of 0.125 milliseconds (ms), where 1 corresponds to 0.125 ms, 2 corresponds to 0.25 ms, 3 corresponds to 0.375 ms, and so on.

During the inactive portion (e.g., when the UE is not in the active portion for monitoring PDCCH or is in a “sleep” state), the UE 115 may enter a sleep state. During the inactive portion (e.g., during off durations), the network may not transmit, or the UE 115 may not receive, control information, which may result in increased latency.

For an RRC CONNECTED mode, one or more LP-WUS procedures may be utilized to trigger PDCCH monitoring. For example, PDCCH monitoring may be triggered by an LP-WUS in conjunction with a C-DRX configuration. In a first use case, LP-WUS monitoring may be performed according to an LP-WUS monitoring configuration before an active portion (e.g., drx-onDurationTimer) of a C-DRX period or cycle to trigger the start of the active portion (e.g., drx-onDurationTimer). The first use case may supplement or replace DCP functionality. In a second use case, LP-WUS monitoring may be performed outside of the C-DRX active portion (e.g., during an inactive portion at least a legacy C-DRX period or cycle) or time according to an LP-WUS monitoring configuration to trigger PDCCH monitoring. PDCCH monitoring may be performed irrespective of the active portion (e.g., drx-onDurationTimer) in some aspects. In a third use case, LP-WUS monitoring may be performed inside of the active portion or time of the C-DRX period (e.g., legacy C-DRX active time) according to an LP-WUS monitoring configuration to trigger PDCCH monitoring.

Some examples of the techniques described herein may be implemented in accordance with the second use case. With the second use case, for instance, the UE 115 may have an active portion of a C-DRX period (e.g., an on duration or active time of C-DRX, where the UE 115 may monitor a PDCCH). During an inactive period (e.g., off duration), the UE 115 may monitor for an LP-WUS. If an LP-WUS is received, the UE 115 may trigger PDCCH monitoring (e.g., additional PDCCH monitoring) outside of the active portion (e.g., active time or on duration of the C-DRX period or cycle).

In some examples of the techniques described herein, the latency of C-DRX may be reduced by utilizing the LP-WUS. For instance, PDCCH monitoring may be triggered based on the LP-WUS with the C-DRX configuration as a power saving procedure for RRC connected mode. In some approaches, the cycles of the additional PDCCH monitoring triggered by LP-WUS may be coordinated with C-DRX cycles. For example, an LP-WUS PDCCH monitoring cycle may evenly divide the C-DRX cycle. Utilizing the even division may allow, in one or more C-DRX cycles, a UE to perform a RRM measurement in one or more time durations in which UE does not monitor the PDCCH (e.g., in cyclical time durations, periodic time durations, or time durations that are the same in multiple cycles). For instance, the RRM measurement procedure may be improved by reducing complexity of time durations in which RRM measurement may be performed. Accordingly, some examples of the techniques described herein may provide approaches for configuration of a LP-WUS in a C-DRX off duration, which may enable RRM measurements with enhanced efficiency. Some aspects of the techniques described herein may enable LP-WUS and C-DRX as co-existing power saving mechanisms, where a PDCCH monitoring occasion may be configured or triggered by the presence of a wake-up signal detected by a relatively low power receiver.

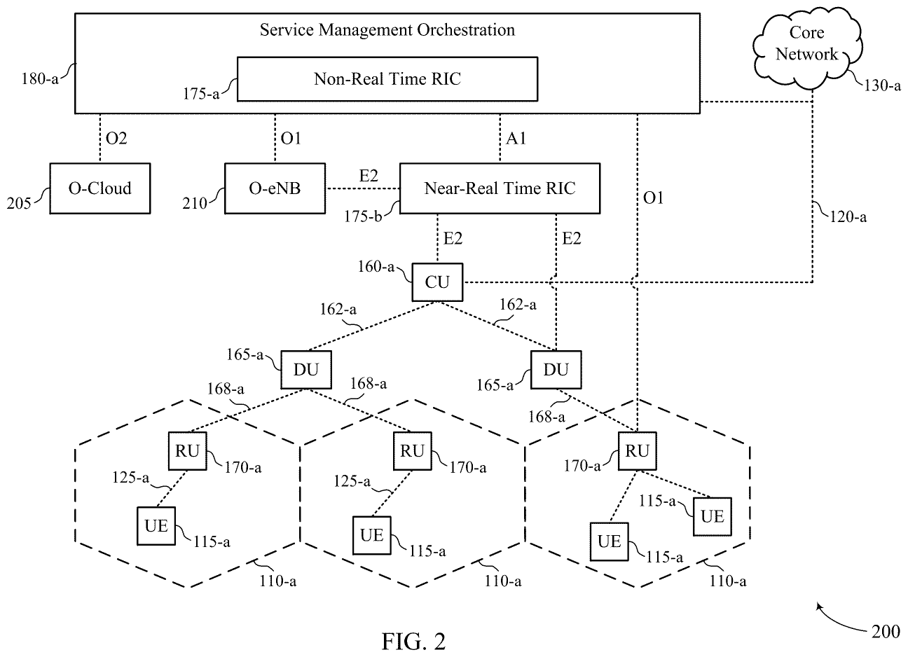

FIG. 2 shows an example of a network architecture 200 (e.g., a disaggregated base station architecture, a disaggregated RAN architecture) that supports configurations for wake-up signals with discontinuous reception in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-avia one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

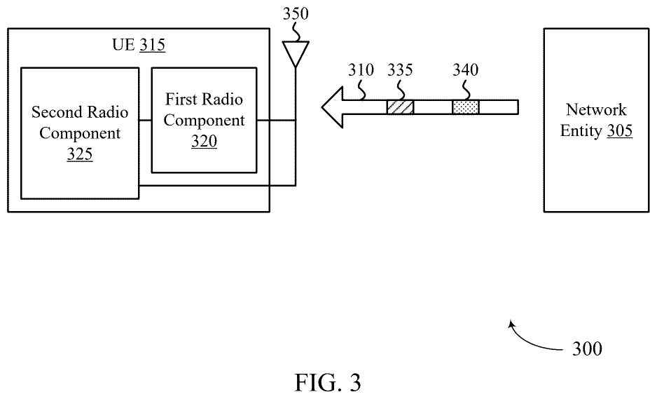

FIG. 3 shows an example of a wireless communications system 300 that supports configurations for wake-up signals with discontinuous reception in accordance with one or more aspects of the present disclosure. The wireless communications system 300 may implement aspects of or may be implemented by aspects of the wireless communications system 100. For example, the wireless communications system 300 includes a UE 315, which may be an example of a UE 115 described with reference to FIG. 1 or a UE 115-a described with reference to FIG. 2. The wireless communications system 300 also includes a network entity 305, which may be an example of a network entity 105 described with reference to FIG. 1 or an RU 170-a, DU 165-a, or CU 160-a described with reference to FIG. 2.

The UE 315 may communicate with the network entity 305 using a link 310, which may be an example of a communication link 125 described with reference to FIG. 1 a communication link 125-a described with reference to FIG. 2, or another link. The link 310 may include a bi-directional link that enables uplink or downlink network communications. For example, the UE 315 may transmit one or more uplink transmissions, such as uplink control signals or uplink data signals, to the network entity 305 using the link 310, or the network entity 305 may transmit one or more downlink transmissions, such as downlink control signals or downlink data signals, to the UE 315 using the link 310.

The UE 315 may include a first radio component 320, a second radio component 325, and one or more antennas 350. The first radio component 320 may be implemented in hardware (e.g., circuitry) or a combination of hardware and instructions (e.g., a processor with instructions). For instance, the first radio component 320 may be a hardware component of the UE 315. The second radio component 325 may be implemented in hardware (e.g., circuitry) or a combination of hardware and instructions (e.g., a processor with instructions). For instance, the second radio component 325 may be a hardware component of the UE 315. Additionally, or alternatively, the first radio component 320 may be a first radio interface or the second radio component 325 may be a second radio interface. In some examples, the first radio component 320 may have reduced complexity, reduced capability, or reduced power consumption relative to the second radio component 325. For instance, the first radio component 320 may perform envelope detection, sequence detection, OOK modulation or demodulation, or signal measurement. The second radio component 325 may be capable of performing one or more functions (e.g., QAM modulation/demodulation, OFDM processing, or baseband processing, among other examples) that the first radio component 320 may not perform (or may not be capable of performing, for instance). Additionally, or alternatively, the first radio component 320 may consume less operating power than an operating power of the second radio component 325. For instance, when the second radio component 325 is in an awake (e.g., active state, operating state, or full power state), the second radio component 325 may consume more power than the first radio component 320 in operation.

In some examples, the first radio component 320 may be an LP-WUR. For instance, the first radio component 320 may monitor signals received via the antenna(s) 350 to provide a WUS to the second radio component 325 or to activate or alert the second radio component 325 based on a WUS. In some aspects, the first radio component 320 may operate when the second radio component 325 is in a sleep state (e.g., a low-power, idle, or inactive state), and may function to provide the WUS to the second radio component 325 to wake or activate the second radio component 325. Additionally, or alternatively, the first radio component 320 may operate when the second radio component 325 is in an awake state.

The network entity 305 may output (e.g., transmit), or the UE 315 may obtain (e.g., receive) configuration information 335 indicating a configuration of the UE 315 to perform PDCCH monitoring during an inactive portion of a C-DRX period. The PDCCH monitoring may be triggered based on a wake-up signal. The wake-up signal may be received via the first radio component 320 (e.g., an LP-WUR) of the UE 315. For instance, the UE 315 may be configured with LP-WUS triggered PDCCH monitoring outside of C-DRX active portions (e.g., active times). As described herein, the first radio component 320 may consume less operating power than the second radio component 325 (e.g., MR) of the UE 315.

The network entity 305 may output (e.g., transmit), or the UE 315 may obtain (e.g., receive), a PDCCH 340 during a PDCCH monitoring occasion that is triggered during a wake-up signal monitoring occasion. For instance, the first radio component 320 may receive a wake-up signal (e.g., from the network entity 305 or another network device) during the wake-up signal monitoring occasion, where the wake-up signal triggers a subsequent PDCCH monitoring occasion. The PDCCH 340 may be received during the PDCCH monitoring occasion. In some approaches, the PDCCH may include control information indicating one or more subsequent communications (e.g., payload or downlink transmissions to the UE 315).

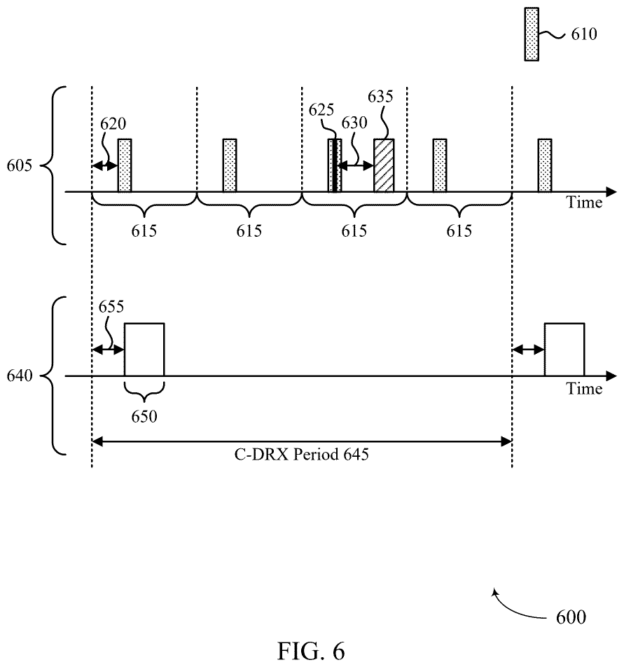

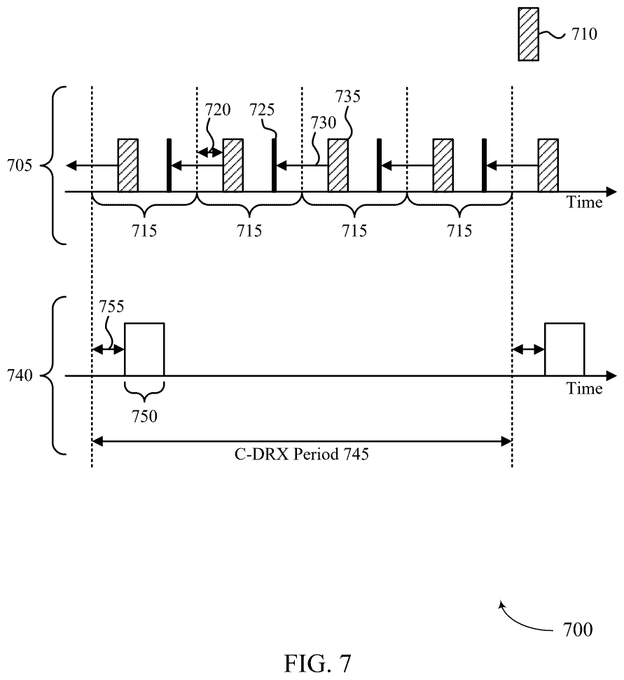

The C-DRX period may be an integer multiple of a first period of the PDCCH monitoring occasion or a second period of the wake-up signal monitoring occasion. The first period of the PDCCH monitoring occasion may be a period or time duration (e.g., cycle) within which a PDCCH monitoring occasion may occur. For instance, the PDCCH monitoring occasion may occupy a subset of time of the first period. Examples of the first period of the PDCCH monitoring occasion are given with reference to FIG. 7. The second period of the wake-up signal monitoring occasion may be a period or time duration (e.g., cycle) within which a wake-up signal monitoring occasion may occur. For instance, the wake-up signal monitoring occasion may occupy a subset of time of the second period. Examples of the second period of the wake-up signal monitoring occasion are given with reference to FIG. 6. In some examples, the first period, the PDCCH monitoring occasion, the second period, or the wake-up signal monitoring occasion may be expressed or implemented as one or more timers. In accordance with some of the techniques described herein, the UE 315 that may be configured with LP-WUS triggered PDCCH monitoring outside C-DRX active times may operate in accordance with a C-DRX period (e.g., cycle) that is a multiple of a cycle of a timer for LP-WUS triggered PDCCH monitoring.

In some examples, the network entity 305 may output (e.g., transmit), or the UE 315 may obtain (e.g., receive) the wake-up signal during the inactive portion of the C-DRX period. The wake-up signal may be transmitted to, or received by, the first radio component 320. The PDCCH monitoring may be triggered based on the wake-up signal received during the inactive portion of the C-DRX period. For instance, one or more LP-WUS monitoring occasions (e.g., periods in which the UE 315 may monitor to receive a wake-up signal) may occur outside a C-DRX active time (e.g., legacy C-DRX active time) according to an LP-WUS monitoring configuration to trigger PDCCH monitoring. In some aspects, the configuration information 335 (or other configuration information from the network entity 305) may indicate that the LP-WUS monitoring configuration.

One or more approaches may be utilized for wake-up signal (e.g., LP-WUS) monitoring occasions (e.g., for a UE 315 in connected mode in the second use case described herein). In a first approach, the network entity 305 may output (e.g., transmit), or the UE 315 may obtain (e.g., receive) an indication of a periodicity or a first offset. For instance, the UE 315 may be configured with one or more LP-WUS monitoring occasions using periodicity and offset parameters (e.g., “LPWUS-SlotPeriodicityAndOffset” or “LPWUS-SymbolWithinSlot”). The wake-up signal monitoring occasion may be based on the periodicity and the first offset.

The PDCCH monitoring occasion may be based on the wake-up signal monitoring occasion. For example, a start of the PDCCH monitoring occasion may be based on a second offset (e.g., “LPWUS-Offset”) from an end of the wake-up signal that is transmitted during the wake-up signal monitoring occasion, from an end of a slot in which the wake-up signal is transmitted, or from an end of a window for multiple wake-up signals. The UE 315 may determine (e.g., deduce) LP-WUS triggered PDCCH monitoring occasions or windows based on each associated LP-WUS monitoring occasion, with a time offset or the second offset. For example, a start of the PDCCH monitoring may be determined (e.g., deduced) from the configuration of the LP-WUS monitoring occasion(s) and a time offset or the second offset starting from the end of the LP-WUS transmission, the end of the last slot where the LP-WUS is transmitted, or the end of window used for one or more LP-WUS monitoring occasions (if supported, for example).

In some aspects for the first approach, LP-WUS monitoring occasions, including a periodicity and offset, may be configured independently from a C-DRX periodicity or offset via one or more RRC parameters, such as “LPWUS-SlotPeriodicityAndOffset” and “LPWUS-SymbolWithinSlot.” The UE 315 may monitor for an LP-WUS in the LP-WUS monitoring occasions and may start a timer for PDCCH monitoring triggered by an LP-WUS, such as “drx-onDurationTimer-LPWUS” after a configured time offset, such as “LPWUS-Offset.” An example of the first approach is given with reference to FIG. 6.

In a second approach, the network entity 305 may output (e.g., transmit), or the UE 315 may obtain (e.g., receive), an indication of a periodicity and a first offset. For example, the UE 315 may be configured with one or more LP-WUS triggered PDCCH monitoring occasions or windows using a periodicity and offset parameters (e.g., drx-CycleStartOffset-LPWUS” or “drx-SlotOffset-LPWUS”). The PDCCH monitoring occasion may be based on the periodicity and the first offset.

The wake-up signal monitoring occasion may be based on the PDCCH monitoring occasion. For example, the UE 315 may determine (e.g., deduce) one or more LP-WUS monitoring occasions based on each associated PDCCH monitoring window, with a time offset or a second offset (e.g., “LPWUS-Offset”). In some approaches, the network entity 305 may output (e.g., transmit), or the UE 315 may obtain (e.g., receive), an indication of a second offset. The wake-up signal monitoring occasion may be based on the second offset from the PDCCH monitoring occasion.

In some aspects of the second approach, the periodicity or offset of the slot (with a timer for PDCCH monitoring triggered by LP-WUS) may be configured by one or more RRC parameters such as “drx-CycleStartOffset-LPWUS” or “drx-SlotOffset-LPWUS.” One or more LP-WUS monitoring occasions, including periodicity and offset, may be determined (e.g., identified) based on the slot at which a drx-onDurationTimer-LPWUS may start and an RRC parameter that indicates the time offset or the second offset such as “LPWUS-Offset” until the slot that drx-onDurationTimer-LPWUS would start. An example of the second approach is given with reference to FIG. 7. One or more aspects of the first approach may be combined with or substituted with one or more aspects of the second approach.

In some examples of the techniques described herein, an RRC parameter (e.g., “LPWUS-duration”) may be utilized (e.g., communicated from the network entity 305 to the UE 315). The RRC parameter (e.g., LPWUS-duration”) may indicate a duration for which the UE 315 monitors for LP-WUS consecutively in time. Consecutive LP-WUS monitoring occasions in time identified by a duration parameter (e.g., “LPWUS-duration”) may be associated with a same slot at which a timer (e.g., “drx-onDurationTimer-LPWUS”) may start. One or more LP-WUS monitoring occasions in time may be determined (e.g., identified) by the duration parameter (e.g., “LPWUS-duration”), where the duration parameter may provide an indication for a same slot at which the timer (e.g., drx-onDurationTimer-LPWUS) may start. For example, the UE 315 may not detect more than one LP-WUS with different indications for the UE 315 in the LP-WUS monitoring occasions associated with the same slot at which the timer (e.g., drx-onDurationTimer-LPWUS) may start.

In some examples, a first subframe offset for an active portion of the C-DRX period may be equal to a second subframe offset for the PDCCH monitoring occasion, or a first slot offset for the active portion of the C-DRX period may be equal to a second slot offset for the PDCCH monitoring occasion. For instance, subframe offsets of on duration of the C-DRX period and of LP-WUS PDCCH monitoring window may be equal. Additionally, or alternatively, slot offsets for the C-DRX and LP-WUS PDCCH monitoring window may be equal. In some approaches (e.g., for the second approach or the first approach), a period of LP-WUS triggered PDCCH monitoring windows (e.g., cycle length) may evenly divide the period of the C-DRX cycle (e.g., the C-DRX cycle period may be an integer multiple of an LP-WUS PDCCH monitoring period).

In some aspects, a first subframe offset for an active portion of the C-DRX period may be equal to a second subframe offset for the wake-up signal monitoring occasion, or a first slot offset for the active portion of the C-DRX period may be equal to a second slot offset for the wake-up signal monitoring occasion. For instance, subframe and slot offsets of the one or more LP-WUS monitoring occasions and the C-DRX may be equal. In some approaches (e.g., for the first approach or the second approach), a period of one or more LP-WUS monitoring occasions may evenly divide the period of the C-DRX cycle.

In some examples, the network entity 305 may output (e.g., transmit), or the UE 315 may obtain (e.g., receive), an indication of the integer multiple. The first period of the PDCCH monitoring occasion or the second period of the wake-up signal monitoring occasion may be based on the integer multiple (e.g., a parameter N). For instance, the network (e.g., network entity 305) may configure N (e.g., may signal an indication of N to the UE 315). One or more of the techniques described herein may be performed based on the integer multiple (e.g., parameter N). In some aspects, the first period of the PDCCH monitoring occasion or the second period of the wake-up signal monitoring occasion may be based on dividing the C-DRX period by the integer multiple (e.g., the parameter N). Given the C-DRX period or cycle, for instance, the UE 315 may calculate either the first period of the one or more LP-WUS PDCCH monitoring occasions (for the second approach, for example) or the second period of one or more LP-WUS monitoring occasions (for the first approach, for example), by dividing the C-DRX period or cycle by N. In some examples, the UE 315 may utilize one or more other C-DRX parameters (e.g., subframe or slot offsets) for multiple approaches (e.g., for the first approach(s) or the second approach(s)).

In some aspects, the integer multiple (e.g., N) may be established (e.g., specified) or stored by the UE 315 or the network entity 305 without signaling an indication of the integer multiple. For instance, the UE 315 may utilize the C-DRX period or cycle and the established integer multiple (e.g., N) to determine the first period or the second period (e.g., may divide the C-DRX period or cycle by the integer multiple to determine the first period or the second period).

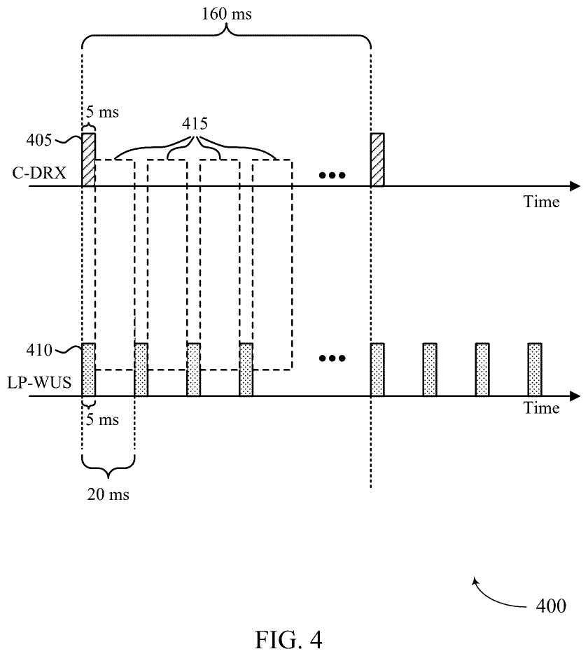

FIG. 4 shows an example of a timing diagram 400 that supports configurations for wake-up signals with discontinuous reception in accordance with one or more aspects of the present disclosure. In some examples, the wireless communications system 300 may operate in accordance with one or more aspects of the example described in FIG. 4. The timing diagram 400 illustrates a C-DRX timeline and an LP-WUS timeline in conjunction with a C-DRX period (e.g., cycle) of 160 ms. The C-DRX timeline illustrates a first duration 405 (e.g., drx-onDurationTimer) of 5 ms, which may be at least a part of an active portion of the C-DRX period. For instance, a second radio component (e.g., second radio component 325 or MR) may monitor or receive a PDCCH during the first duration 405 in some cases.

The LP-WUS timeline illustrates a PDCCH monitoring occasion 410 (e.g., pdcchOnDurationTimer) of 5 ms may be triggered based on an LP-WUS received by a UE (e.g., based on an LP-WUS received by a first radio component 320 of the UE 315). A first period of the PDCCH monitoring occasion 410 may repeat with a periodicity of 20 ms during the C-DRX period. A UE (e.g., UE 315) may utilize a second radio component (e.g., second radio component 325 or MR) to monitor for a PDCCH during the PDCCH monitoring occasion 410.

As illustrated in FIG. 4, open periods 415 may occur (e.g., repeated open periods 415 based on the periodicity of the first period may occur), which may be time ranges in which a UE may perform one or more measurements (e.g., RRM measurements). For instance, the UE (e.g., UE 315) may utilize a second radio component (e.g., second radio component 325 or MR) for RRM measurements. If the pattern of open periods is the same for multiple C-DRX periods or cycles, the UE may perform periodic measurements. In some approaches, the UE (e.g., UE 315) may be configured with a pattern of monitoring occasions 410 (or LP-WUS monitoring occasions) or a pattern of LP-WUS triggered PDCCH monitoring that may be the same or similar (or may repeat) for multiple C-DRX periods or cycles, such that a pattern of open periods 415 may be the same or similar for multiple C-DRX periods or cycles. For instance, the UE (e.g., UE 315) may receive information (e.g., configuration information, a configuration message, or other information from another device, such as a network entity 305) for configuring a pattern of monitoring occasions 410 (or LP-WUS monitoring occasions) or a pattern of LP-WUS triggered PDCCH monitoring that may be the same or similar (or that may repeat) for multiple C-DRX periods or cycles. In some aspects, the monitoring occasions 410 may be similar or identical in multiple C-DRX periods. For instance, a period of monitoring occasions 410 may evenly divide a DRX period. Configuration signaling to achieve similar or identical monitoring occasions 410 (or LP-WUS monitoring occasions) over C-DRX periods or cycles may be additionally or alternatively utilized. For example, the network (e.g., network entity 305) may configure the UE (e.g., UE 315) with LP-WUS monitoring occasions or PDCCH monitoring occasions in the inactive portion (e.g., off duration) of a C-DRX period, such that the inactive portions of multiple DRX periods are similar or the same, as related to the LP-WUS. In accordance with some of the techniques described herein, the C-DRX period may be an integer multiple of the first period to allow periodic or repeating open periods for one or more measurements (e.g., RRM measurement(s)).

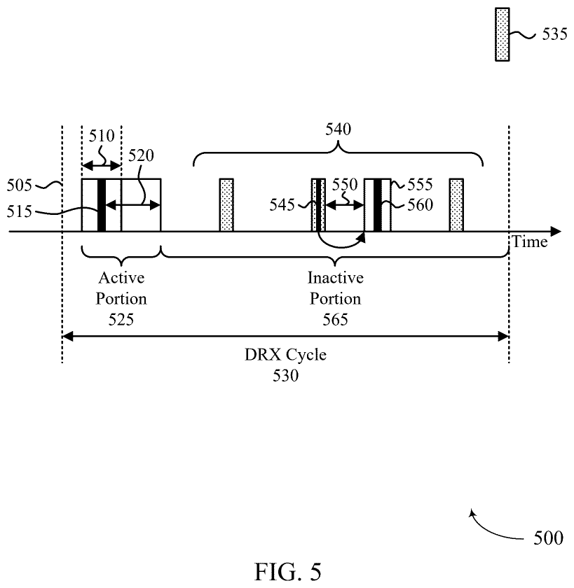

FIG. 5 shows an example of a timing diagram 500 that supports configurations for wake-up signals with discontinuous reception in accordance with one or more aspects of the present disclosure. In some examples, the UE 315 or the network entity 305 described with reference to FIG. 3 may operate in accordance with one or more aspects of the timing diagram 500.

The timing diagram 500 illustrates an example of a DRX cycle 530. The DRX cycle 530 may be an example of the C-DRX period described herein, or may be utilized instead of the C-DRX period described herein. The DRX cycle 530 may begin 505 at the beginning of a subframe. As illustrated in FIG. 5, the DRX cycle 530 may include an active portion 525 (e.g., active time) and an inactive portion 565 (e.g., inactive time). The active portion 525 may include a first duration 510 (e.g., drx-OnDurationTimer) and a second duration 520 (e.g., drx-InactivityTimer). In this example, a PDCCH 515 related to a transmission (e.g., a subsequent data transmission) may be received during the first duration 510. The second duration 520 may extend from the PDCCH 515 to the end of the active portion 525.

A UE may perform LP-WUS monitoring 540 during the inactive portion 565. For instance, during one or more LP-WUS monitoring occasions 535, the UE may monitor to receive an LP-WUS 545 (using an LP-WUR, for example). As illustrated in FIG. 5, the UE may receive the LP-WUS 545 during an LP-WUS monitoring occasion. The LP-WUS 545 may trigger PDCCH monitoring (e.g., a PDCCH monitoring occasion 555). The PDCCH monitoring occasion 555 may occur at an offset 550 (e.g., a fixed offset in time) from the LP-WUS monitoring occasion 535 in which the LP-WUS 545 is received.

In some aspects, the PDCCH monitoring occasion 555 may occur during a time span in which a timer is running. For instance, the reception of the LP-WUS 545 may trigger a timer to begin running after the offset 550. In the example of FIG. 5, the UE receives a PDCCH 560 during the PDCCH monitoring occasion 555. For instance, the PDCCH 560 may include control information to activate the UE for reception of payload data or other information (e.g., subsequent to the PDCCH 560).

Some examples of the techniques described herein may address how LP-WUS monitoring occasions 535 and one or more associated PDCCH monitoring occasions 555 may be configured, defined, or determined. For instance, each of the LP-WUS monitoring occasions 535 may be included in a respective second period, where the DRX cycle 530 is an integer multiple of the second period, or where the second period is an even divisor of the DRX cycle 530, which may allow periodic open periods for measurement.

FIG. 6 shows an example of a timing diagram 600 that supports configurations for wake-up signals with discontinuous reception in accordance with one or more aspects of the present disclosure. In some examples, the UE 315 or the network entity 305 described with reference to FIG. 3 may operate in accordance with one or more aspects of the timing diagram 600.

The timing diagram 600 illustrates an example of a C-DRX period 645. The C-DRX period 645 may be an example of the one or more of the C-DRX periods or DRX cycles described herein, or may be utilized instead of one or more of the C-DRX periods or DRX cycles described herein. The C-DRX period 645 may begin at the beginning of a subframe.

The timing diagram 600 illustrates a first timeline 605 and a second timeline 640. The second timeline 640 may illustrate C-DRX timing. As illustrated in FIG. 6, the C-DRX period 645 may include an active portion 650 (e.g., active time). The active portion 650 may occur at a DRX offset 655 from the beginning of the subframe. The active portion 650 may occupy an amount of time in accordance with a DRX on duration timer. An inactive portion (e.g., inactive time) of the C-DRX period 645 may be (or may occupy) time after the active portion 650 to the end of the C-DRX period 645.

The first timeline 605 may illustrate LP-WUS monitoring occasions 610. As illustrated in FIG. 6, each of the LP-WUS monitoring occasions 610 may occur during a respective second period 615 of an LP-WUS monitoring occasion 610 (e.g., an LP-WUS monitoring occasion period). Each of the LP-WUS monitoring occasions 610 may be included a respective second period 615, where the C-DRX period 645 is an integer multiple of the second period 615, or where the second period 615 is an even divisor of the C-DRX period 645.

An LP-WUS monitoring occasion 610 may occur at a first offset 620 (e.g., an LP-WUS monitoring occasion offset) from the beginning of the subframe or from a beginning of a respective second period 615. For instance, configuration information output from a network entity may indicate when the LP-WUS monitoring occasions 610 occur (e.g., may indicate a first offset 620 or a periodicity of the second periods 615 for the LP-WUS monitoring occasions 610).

During one or more LP-WUS monitoring occasions 610, the UE may monitor to receive an LP-WUS 625 (using an LP-WUR, for example). In some examples, an RRC parameter (output from a network entity, for instance), may indicate a duration where the UE monitors the LP-WUS (e.g., consecutively in time). As illustrated in FIG. 6, the UE may receive the LP-WUS 625 during an LP-WUS monitoring occasion 610. The LP-WUS 625 may trigger PDCCH monitoring (e.g., a PDCCH monitoring occasion 635). The PDCCH monitoring occasion 635 may occur at a second offset 630 based on the LP-WUS monitoring occasion 610 in which the LP-WUS 625 is received. For instance, a start of the PDCCH monitoring occasion 635 may be based on a second offset 630 from an end of the LP-WUS 625 that is transmitted during the LP-WUS monitoring occasion 610, from an end of a slot in which the LP-WUS 625 is transmitted, or from an end of a window for multiple LP-WUSs, as described with reference to FIG. 3.

In some aspects, the PDCCH monitoring occasion 635 may occur during a time span in which a timer is running (e.g., a timer for PDCCH monitoring triggered by the LP-WUS 625). For instance, the reception of the LP-WUS 625 may trigger a timer to begin running after the second offset 630. A UE may receive a PDCCH during the PDCCH monitoring occasion 635.

FIG. 7 shows an example of a timing diagram 700 that supports configurations for wake-up signals with discontinuous reception in accordance with one or more aspects of the present disclosure. In some examples, the UE 315 or the network entity 305 described with reference to FIG. 3 may operate in accordance with one or more aspects of the timing diagram 700.

The timing diagram 700 illustrates an example of a C-DRX period 745. The C-DRX period 745 may be an example of the one or more of the C-DRX periods or DRX cycles described herein, or may be utilized instead of one or more of the C-DRX periods or DRX cycles described herein. The C-DRX period 745 may begin at the beginning of a subframe.

The timing diagram 700 illustrates a first timeline 705 and a second timeline 740. The second timeline 740 may illustrate C-DRX timing. As illustrated in FIG. 7, the C-DRX period 745 may include an active portion 750 (e.g., active time). The active portion 750 may occur at a DRX offset 755 from the beginning of the subframe. The active portion 750 may occupy an amount of time in accordance with a DRX on duration timer. An inactive portion (e.g., inactive time) of the C-DRX period 745 may be (or may occupy) time after the active portion 750 to the end of the C-DRX period 745.

The first timeline 705 may illustrate PDCCH monitoring occasions 710 (e.g., LP-WUS triggered PDCCH monitoring). As illustrated in FIG. 7, each of the PDCCH monitoring occasions 710 may occur during a respective first period 715 of a PDCCH monitoring occasion 710 (e.g., a period of LP-WUS triggered PDCCH monitoring occasions). Each of the PDCCH monitoring occasions 710 may be included a respective first period 715, where the C-DRX period 745 is an integer multiple of the first period 715, or where the first period 715 is an even divisor of the C-DRX period 745.

A PDCCH monitoring occasion 710 may occur at a first offset 720 (e.g., a PDCCH monitoring occasion or window offset) from the beginning of the subframe or from a beginning of a respective first period 715. For instance, configuration information output from a network entity may indicate when the PDCCH monitoring occasions 710 or windows occur (e.g., may indicate a first offset 720 or a periodicity of the first periods 715 for the PDCCH monitoring occasions 710).

As illustrated in FIG. 7, the UE may receive an LP-WUS 725. The LP-WUS 725 may trigger PDCCH monitoring (e.g., a PDCCH monitoring occasion 735). The LP-WUS 725 may be received at a second offset 730 (e.g., an LPWUS-Offset) from the PDCCH monitoring occasion 735.

In some aspects, the PDCCH monitoring occasion 735 may occur during a time span in which a timer is running. For instance, if PDCCH monitoring is triggered by an LP-WUS 725, the PDCCH monitoring occasion 735 may occur during (e.g., may span) a drx-onDurationTimer-LPWUS. A UE may receive a PDCCH during the PDCCH monitoring occasion 735. In some examples, LP-WUS monitoring occasions, including a periodicity and offset, may be identified based on the slot in which the timer for the PDDCH monitoring occasion 735 (e.g., a drx-onDurationTimer-LPWUS) may start. In some aspects, an RRC parameter (e.g., signaled from a network entity to the UE) may indicate the second offset 730 (e.g., a time offset such as an LPWUS-Offset) until the slot that the timer (e.g., drx-onDurationTimer-LPWUS) may start.

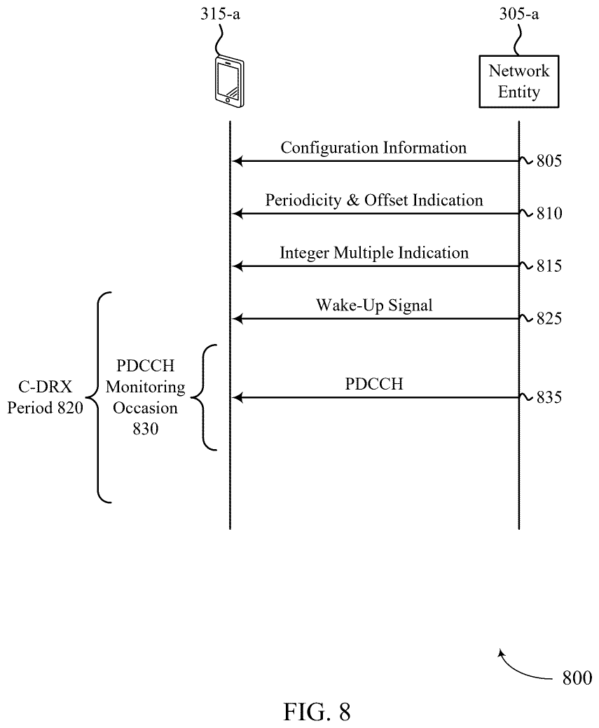

FIG. 8 shows an example of a process flow 800 that supports configurations for wake-up signals with discontinuous reception in accordance with one or more aspects of the present disclosure. The process flow 800 may additionally include an network entity 305-a, which may be an example of the network entity 105, CU 160, CU 160-a, DU 165, DU 165-a, RU 170, RU 170-a, TRP, base station, or other network device, as described herein.

In the following description of the process flow 800, the communications between the UE 315-a and the network entity 305-a may be transmitted in the example order shown or in a different order than the example order shown. Additionally, or alternatively, the operations performed by the UE 315-a or the network entity 305-a may be performed in different orders or at different times. One or more operations may be omitted from the process flow 800, or one or more other operations may be added to the process flow 800. Although some operations or signaling may be shown to occur at different times for discussion purposes, these operations may actually occur at separate (e.g., non-overlapping) times, at the same time, in overlapping time periods in some examples.

In some approaches, the UE 315-a may output (e.g., transmit), or the network entity 305-a may obtain (e.g., receive) capability information indicating a capability of the UE 315-a to perform wake-up signal (e.g., LP-WUS) signal triggered PDCCH monitoring during an inactive portion of a C-DRX period, a capability of the UE 315-a to determine a PDCCH monitoring occasion based on a wake-up signal (e.g., LP-WUS) monitoring occasion, a capability of the UE 315-a to determine a wake-up signal (e.g., LP-WUS) monitoring occasion based on a PDCCH monitoring occasion, to determine a first period of a PDCCH monitoring occasion based on an integer multiple, to determine a second period of a wake-up signal monitoring occasion based on an integer multiple, or any combination thereof.

At 805, the network entity 305-a may output (e.g., transmit), or the UE 315-a may obtain (e.g., receive), configuration information. In some examples, the configuration information may be communicated (e.g., transmitted or received) as described with reference to FIG. 3. In some examples, the configuration information may be generated or communicated based on (e.g., in accordance with) the capability information.

At 810, the network entity 305-a may output (e.g., transmit), or the UE 315-a may obtain (e.g., receive), an indication of a periodicity and a first offset. In some examples, the indication of the periodicity and the first offset may be communicated (e.g., transmitted or received) as described with reference to FIG. 3.

At 815, the network entity 305-a may output (e.g., transmit), or the UE 315-a may obtain (e.g., receive), an indication of an integer multiple. In some examples, the indication of the integer multiple may be communicated (e.g., transmitted or received) as described with reference to FIG. 3. The UE 315-a may utilize the configuration information, the indication of the periodicity and the first offset, or the indication of the integer multiple to determine a timing for the occurrence of one or more wake-up signal monitoring occasions or one or more PDCCH monitoring occasions. For instance, the UE 315-a may divide a C-DRX period by the integer multiple to determine a first period for PDCCH monitoring occasions or a second period for wake-up signal monitoring occasions. In some examples, the configuration information, the indication of the periodicity and the first offset, or the indication of the integer multiple may be communicated in one message or in two or more separate messages.

At 820, a C-DRX period may occur. The C-DRX period may be configured by the network entity 305-a (e.g., signaled to the UE 315-a).

At 825, during the C-DRX period, the network entity 305-a may output (e.g., transmit), or the UE 315-a may obtain (e.g., receive), a wake-up signal (e.g., an LP-WUS communicated to an LP-WUR). In some examples, the wake-up signal may be communicated (e.g., transmitted or received) as described with reference to FIG. 3. The wake-up signal may trigger a PDCCH monitoring occasion at 830 during the C-DRX period 820. The UE 315-a may determine a timing of a wake-up signal monitoring occasion or of a PDCCH monitoring occasion in accordance with one or more of the examples described with reference to FIG. 3, FIG. 4, FIG. 5, FIG. 6, or FIG. 7.

At 835, the network entity 305-a may output (e.g., transmit), or the UE 315-a may obtain (e.g., receive), a PDCCH during the PDCCH monitoring occasion. In some examples, the PDCCH may be communicated (e.g., transmitted or received) as described with reference to FIG. 3.

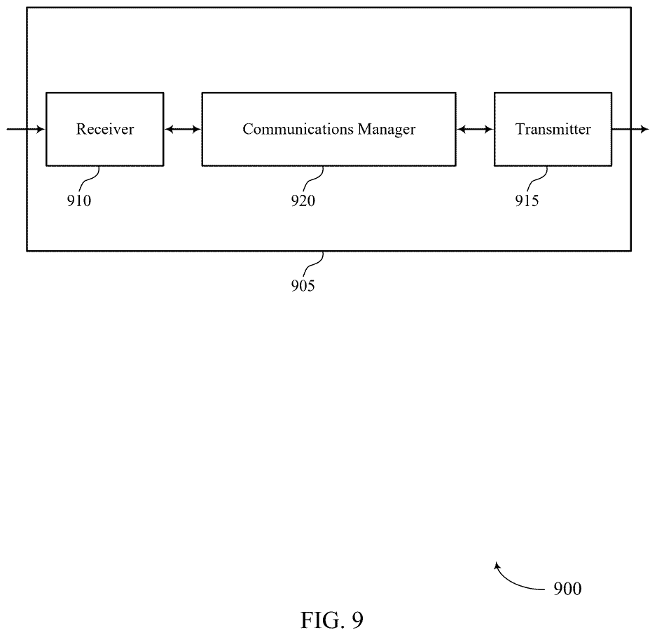

FIG. 9 shows a block diagram 900 of a device 905 that supports configurations for wake-up signals with discontinuous reception in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to configurations for wake-up signals with discontinuous reception). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to configurations for wake-up signals with discontinuous reception). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of configurations for wake-up signals with discontinuous reception as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for receiving, from a network entity, configuration information indicating a configuration of the UE to perform PDCCH monitoring during an inactive portion of a C-DRX period, the PDCCH monitoring triggered based on a wake-up signal received via a first radio component of the UE that consumes less operating power than a second radio component of the UE. The communications manager 920 is capable of, configured to, or operable to support a means for receiving, from the network entity, a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, or more efficient utilization of communication resources.

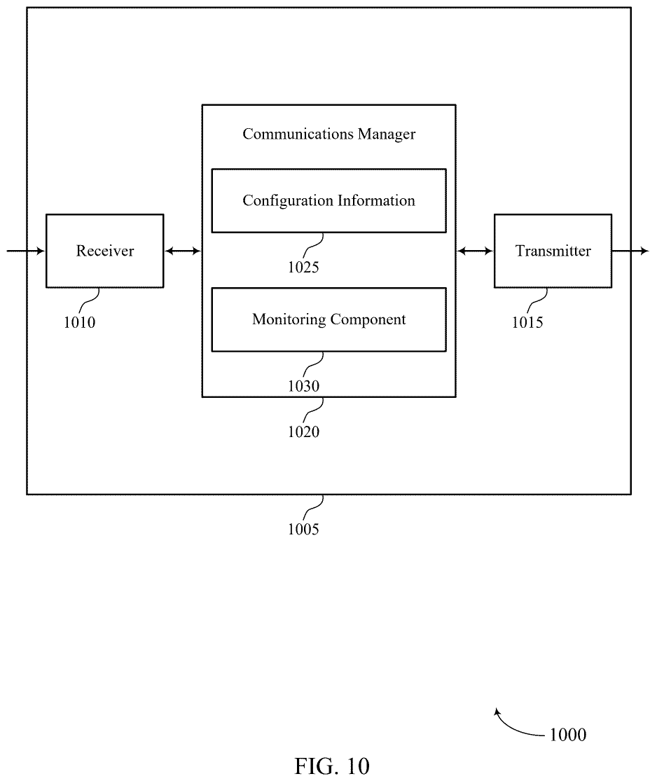

FIG. 10 shows a block diagram 1000 of a device 1005 that supports configurations for wake-up signals with discontinuous reception in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to configurations for wake-up signals with discontinuous reception). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to configurations for wake-up signals with discontinuous reception). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of configurations for wake-up signals with discontinuous reception as described herein. For example, the communications manager 1020 may include a configuration information 1025 a monitoring component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The configuration information 1025 is capable of, configured to, or operable to support a means for receiving, from a network entity, configuration information indicating a configuration of the UE to perform PDCCH monitoring during an inactive portion of a C-DRX period, the PDCCH monitoring triggered based on a wake-up signal received via a first radio component of the UE that consumes less operating power than a second radio component of the UE. The monitoring component 1030 is capable of, configured to, or operable to support a means for receiving, from the network entity, a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

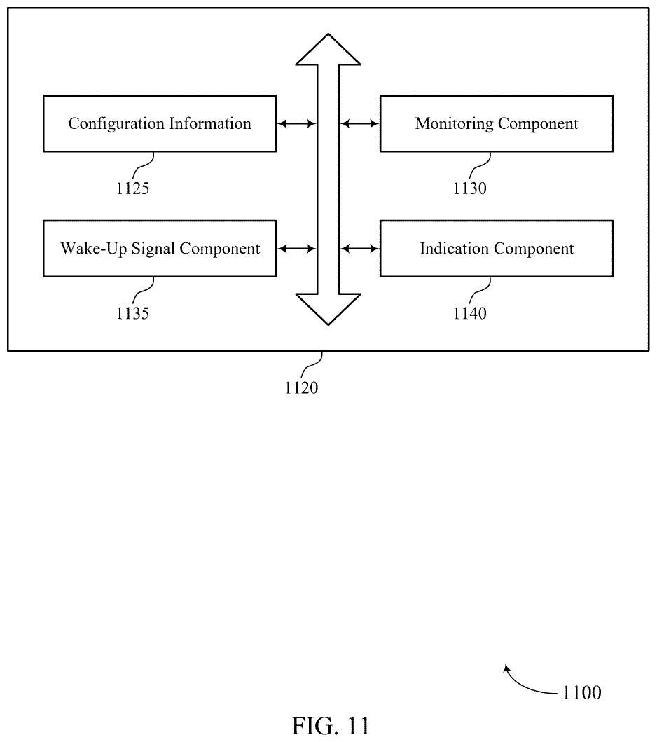

FIG. 11 shows a block diagram 1100 of a communications manager 1120 that supports configurations for wake-up signals with discontinuous reception in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of configurations for wake-up signals with discontinuous reception as described herein. For example, the communications manager 1120 may include a configuration information 1125, a monitoring component 1130, a wake-up signal component 1135, an indication component 1140, or any combination thereof. Each of these components, or components or subcomponents thereof (e.g., one or more processors, one or more memories), may communicate, directly or indirectly, with one another (e.g., via one or more buses).

The configuration information 1125 is capable of, configured to, or operable to support a means for receiving, from a network entity, configuration information indicating a configuration of the UE to perform PDCCH monitoring during an inactive portion of a C-DRX period, the PDCCH monitoring triggered based on a wake-up signal received via a first radio component of the UE that consumes less operating power than a second radio component of the UE. The monitoring component 1130 is capable of, configured to, or operable to support a means for receiving, from the network entity, a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

In some examples, the wake-up signal component 1135 is capable of, configured to, or operable to support a means for receiving, via the first radio component, the wake-up signal during the inactive portion of the C-DRX period, the PDCCH monitoring triggered based on the wake-up signal received during the inactive portion of the C-DRX period.

In some examples, the indication component 1140 is capable of, configured to, or operable to support a means for receiving, from the network entity, an indication of a periodicity and a first offset, where the wake-up signal monitoring occasion is based on the periodicity and the first offset, and where the PDCCH monitoring occasion is based on the wake-up signal monitoring occasion.

In some examples, a start of the PDCCH monitoring occasion is based on a second offset from an end of the wake-up signal that is transmitted during the wake-up signal monitoring occasion, from an end of a slot in which the wake-up signal is transmitted, or from an end of a window for multiple wake-up signals.

In some examples, the indication component 1140 is capable of, configured to, or operable to support a means for receiving, from the network entity, an indication of a periodicity and a first offset, where the PDCCH monitoring occasion is based on the periodicity and the first offset, and where the wake-up signal monitoring occasion is based on the PDCCH monitoring occasion.

In some examples, the indication component 1140 is capable of, configured to, or operable to support a means for receiving, from the network entity, an indication of a second offset, where the wake-up signal monitoring occasion is based on the second offset from the PDCCH monitoring occasion.

In some examples, a first subframe offset for an active portion of the C-DRX period is equal to a second subframe offset for the PDCCH monitoring occasion or a first slot offset for the active portion of the C-DRX period is equal to a second slot offset for the PDCCH monitoring occasion.

In some examples, a first subframe offset for an active portion of the C-DRX period is equal to a second subframe offset for the wake-up signal monitoring occasion or a first slot offset for the active portion of the C-DRX period is equal to a second slot offset for the wake-up signal monitoring occasion.

In some examples, the indication component 1140 is capable of, configured to, or operable to support a means for receiving, from the network entity, an indication of the integer multiple, where the first period of the PDCCH monitoring occasion or the second period of the wake-up signal monitoring occasion is based on the integer multiple.

In some examples, the first period of the PDCCH monitoring occasion or the second period of the wake-up signal monitoring occasion is based on dividing the C-DRX period by the integer multiple.

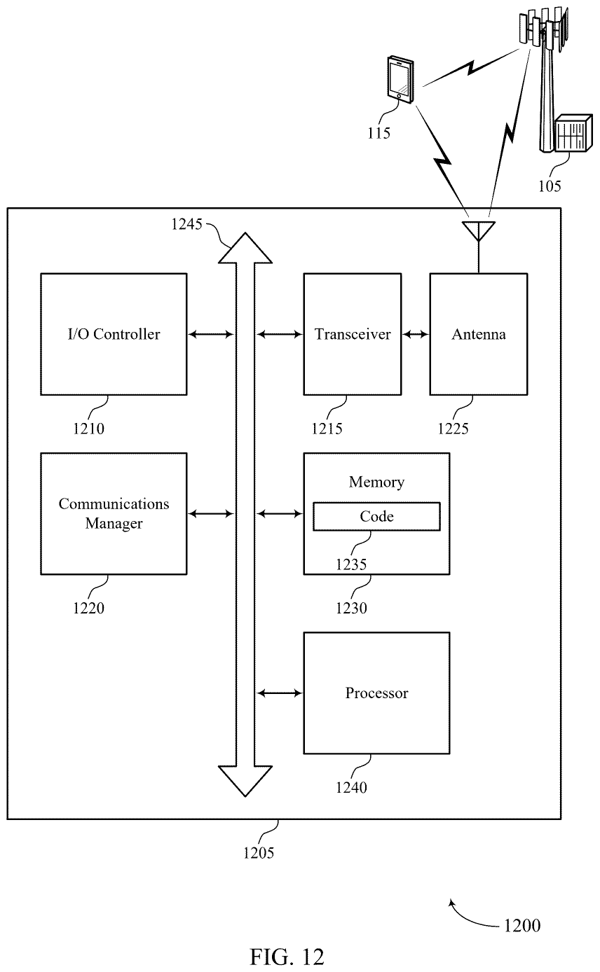

FIG. 12 shows a diagram of a system 1200 including a device 1205 that supports configurations for wake-up signals with discontinuous reception in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting configurations for wake-up signals with discontinuous reception). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

For example, the communications manager 1220 is capable of, configured to, or operable to support a means for receiving, from a network entity, configuration information indicating a configuration of the UE to perform PDCCH monitoring during an inactive portion of a C-DRX period, the PDCCH monitoring triggered based on a wake-up signal received via a first radio component of the UE that consumes less operating power than a second radio component of the UE. The communications manager 1220 is capable of, configured to, or operable to support a means for receiving, from the network entity, a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

By including or configuring the communications manager 1220 in accordance with examples as described herein, the device 1205 may support techniques for improved communication reliability, reduced latency, reduced power consumption, more efficient utilization of communication resources, improved coordination between devices, longer battery life, or improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of configurations for wake-up signals with discontinuous reception as described herein, or the at least one processor 1240 and the at least one memory 1230 may be otherwise configured to, individually or collectively, perform or support such operations.

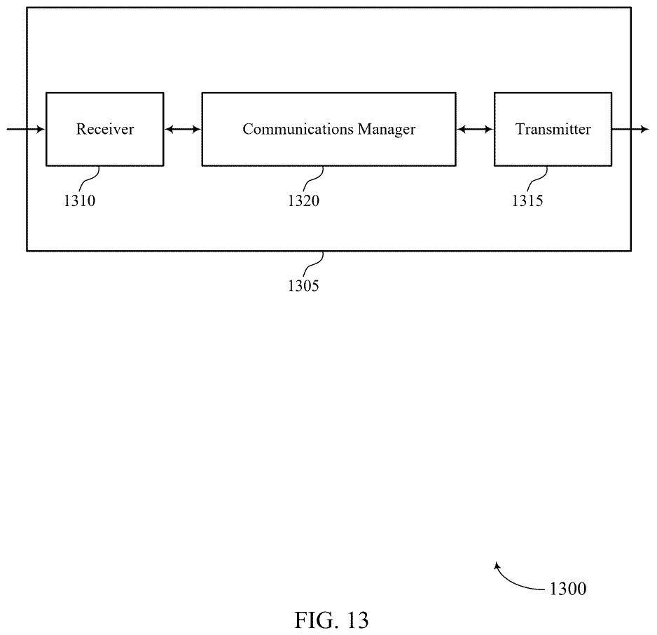

FIG. 13 shows a block diagram 1300 of a device 1305 that supports configurations for wake-up signals with discontinuous reception in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of configurations for wake-up signals with discontinuous reception as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

For example, the communications manager 1320 is capable of, configured to, or operable to support a means for outputting configuration information indicating a configuration to perform PDCCH monitoring during an inactive portion of a C-DRX period, the PDCCH monitoring triggered based on a wake-up signal. The communications manager 1320 is capable of, configured to, or operable to support a means for outputting a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced processing, reduced power consumption, or more efficient utilization of communication resources.

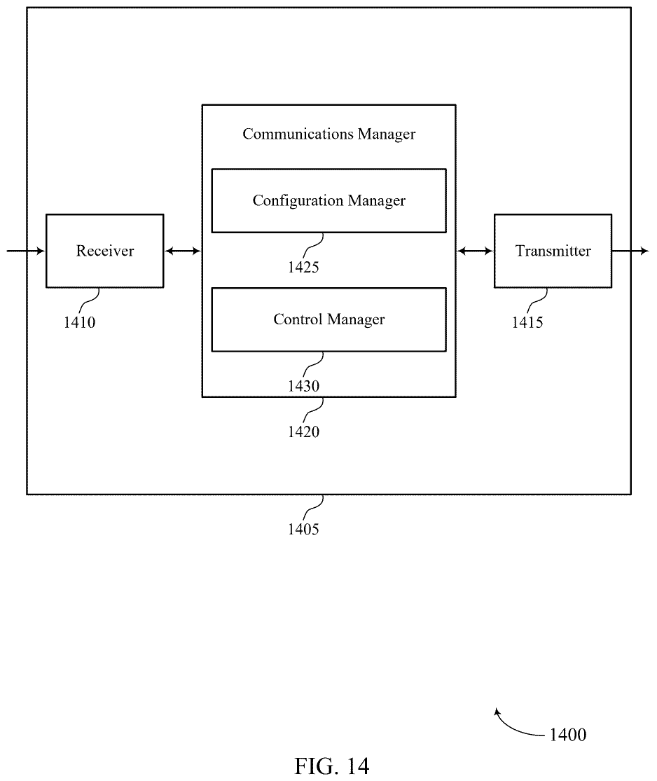

FIG. 14 shows a block diagram 1400 of a device 1405 that supports configurations for wake-up signals with discontinuous reception in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of configurations for wake-up signals with discontinuous reception as described herein. For example, the communications manager 1420 may include a configuration manager 1425 a control manager 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The configuration manager 1425 is capable of, configured to, or operable to support a means for outputting configuration information indicating a configuration to perform PDCCH monitoring during an inactive portion of a C-DRX period, the PDCCH monitoring triggered based on a wake-up signal. The control manager 1430 is capable of, configured to, or operable to support a means for outputting a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

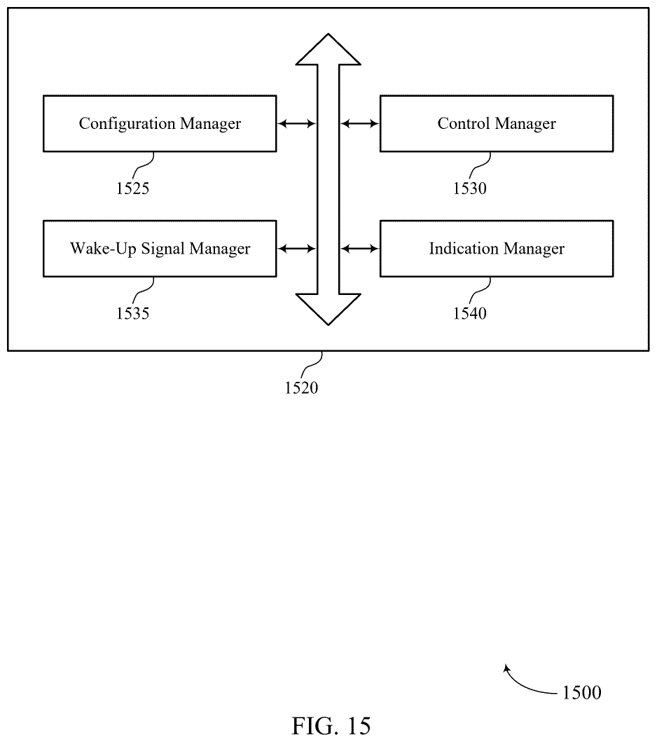

FIG. 15 shows a block diagram 1500 of a communications manager 1520 that supports configurations for wake-up signals with discontinuous reception in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of configurations for wake-up signals with discontinuous reception as described herein. For example, the communications manager 1520 may include a configuration manager 1525, a control manager 1530, a wake-up signal manager 1535, an indication manager 1540, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The configuration manager 1525 is capable of, configured to, or operable to support a means for outputting configuration information indicating a configuration to perform PDCCH monitoring during an inactive portion of a C-DRX period, the PDCCH monitoring triggered based on a wake-up signal. The control manager 1530 is capable of, configured to, or operable to support a means for outputting a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

In some examples, the wake-up signal manager 1535 is capable of, configured to, or operable to support a means for outputting the wake-up signal during the inactive portion of the C-DRX period to trigger the PDCCH monitoring.

In some examples, the indication manager 1540 is capable of, configured to, or operable to support a means for outputting an indication of a periodicity and a first offset, where the wake-up signal monitoring occasion is based on the periodicity and the first offset, and where the PDCCH monitoring occasion is based on the wake-up signal monitoring occasion.

In some examples, a start of the PDCCH monitoring occasion is based on a second offset from an end of the wake-up signal that is transmitted during the wake-up signal monitoring occasion, from an end of a slot in which the wake-up signal is transmitted, or from an end of a window for multiple wake-up signals.

In some examples, the indication manager 1540 is capable of, configured to, or operable to support a means for outputting an indication of a periodicity and a first offset, where the PDCCH monitoring occasion is based on the periodicity and the first offset, and where the wake-up signal monitoring occasion is based on the PDCCH monitoring occasion.

In some examples, the indication manager 1540 is capable of, configured to, or operable to support a means for outputting an indication of a second offset, where the wake-up signal monitoring occasion is based on the second offset from the PDCCH monitoring occasion.

In some examples, a first subframe offset for an active portion of the C-DRX period is equal to a second subframe offset for the PDCCH monitoring occasion or a first slot offset for the active portion of the C-DRX period is equal to a second slot offset for the PDCCH monitoring occasion.

In some examples, a first subframe offset for an active portion of the C-DRX period is equal to a second subframe offset for the wake-up signal monitoring occasion or a first slot offset for the active portion of the C-DRX period is equal to a second slot offset for the wake-up signal monitoring occasion.

In some examples, the indication manager 1540 is capable of, configured to, or operable to support a means for outputting an indication of the integer multiple, where the first period of the PDCCH monitoring occasion or the second period of the wake-up signal monitoring occasion is based on the integer multiple.

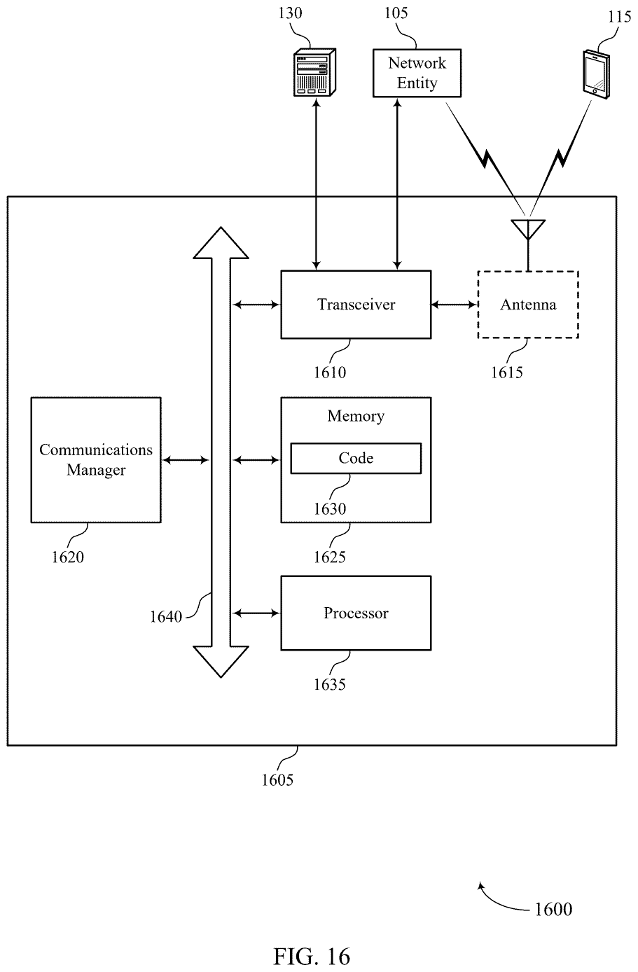

FIG. 16 shows a diagram of a system 1600 including a device 1605 that supports configurations for wake-up signals with discontinuous reception in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting configurations for wake-up signals with discontinuous reception). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

For example, the communications manager 1620 is capable of, configured to, or operable to support a means for outputting configuration information indicating a configuration to perform PDCCH monitoring during an inactive portion of a C-DRX period, the PDCCH monitoring triggered based on a wake-up signal. The communications manager 1620 is capable of, configured to, or operable to support a means for outputting a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion.

By including or configuring the communications manager 1620 in accordance with examples as described herein, the device 1605 may support techniques for improved communication reliability, reduced latency, reduced power consumption, more efficient utilization of communication resources, improved coordination between devices, longer battery life, or improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of configurations for wake-up signals with discontinuous reception as described herein, or the at least one processor 1635 and the at least one memory 1625 may be otherwise configured to, individually or collectively, perform or support such operations.

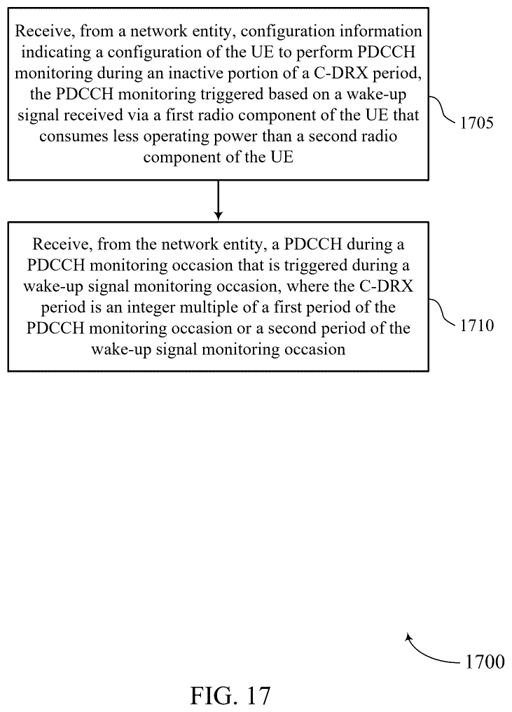

FIG. 17 shows a flowchart illustrating a method 1700 that supports configurations for wake-up signals with discontinuous reception in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, configuration information indicating a configuration of the UE to perform PDCCH monitoring during an inactive portion of a C-DRX period, the PDCCH monitoring triggered based on a wake-up signal received via a first radio component of the UE that consumes less operating power than a second radio component of the UE. The operations of 1705 may be performed in accordance with examples as disclosed herein. In some examples, aspects of the operations of 1705 may be performed by a configuration information 1125 as described with reference to FIG. 11.

At 1710, the method may include receiving, from the network entity, a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion. The operations of 1710 may be performed in accordance with examples as disclosed herein. In some examples, aspects of the operations of 1710 may be performed by a monitoring component 1130 as described with reference to FIG. 11.

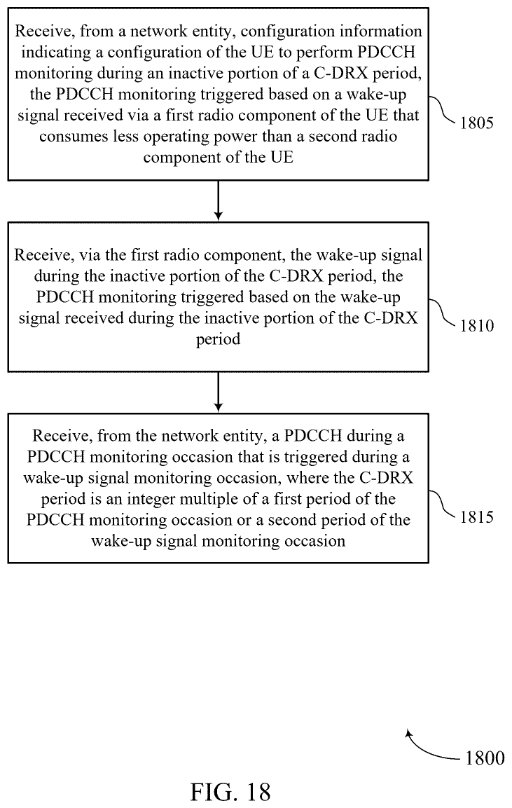

FIG. 18 shows a flowchart illustrating a method 1800 that supports configurations for wake-up signals with discontinuous reception in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving, from a network entity, configuration information indicating a configuration of the UE to perform PDCCH monitoring during an inactive portion of a C-DRX period, the PDCCH monitoring triggered based on a wake-up signal received via a first radio component of the UE that consumes less operating power than a second radio component of the UE. The operations of 1805 may be performed in accordance with examples as disclosed herein. In some examples, aspects of the operations of 1805 may be performed by a configuration information 1125 as described with reference to FIG. 11.

At 1810, the method may include receiving, via the first radio component, the wake-up signal during the inactive portion of the C-DRX period, the PDCCH monitoring triggered based on the wake-up signal received during the inactive portion of the C-DRX period. The operations of 1810 may be performed in accordance with examples as disclosed herein. In some examples, aspects of the operations of 1810 may be performed by a wake-up signal component 1135 as described with reference to FIG. 11.

At 1815, the method may include receiving, from the network entity, a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion. The operations of 1815 may be performed in accordance with examples as disclosed herein. In some examples, aspects of the operations of 1815 may be performed by a monitoring component 1130 as described with reference to FIG. 11.

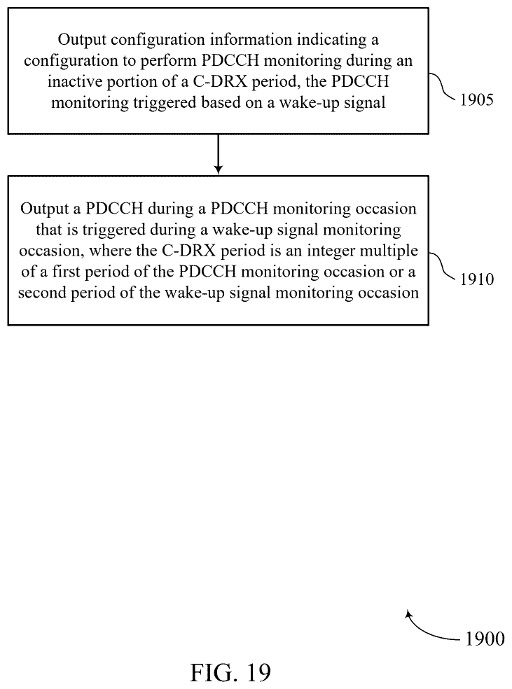

FIG. 19 shows a flowchart illustrating a method 1900 that supports configurations for wake-up signals with discontinuous reception in accordance with one or more aspects of the present disclosure. The operations of the method 1900 may be implemented by a network entity or its components as described herein. For example, the operations of the method 1900 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1905, the method may include outputting configuration information indicating a configuration to perform PDCCH monitoring during an inactive portion of a C-DRX period, the PDCCH monitoring triggered based on a wake-up signal. The operations of 1905 may be performed in accordance with examples as disclosed herein. In some examples, aspects of the operations of 1905 may be performed by a configuration manager 1525 as described with reference to FIG. 15.

At 1910, the method may include outputting a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion. The operations of 1910 may be performed in accordance with examples as disclosed herein. In some examples, aspects of the operations of 1910 may be performed by a control manager 1530 as described with reference to FIG. 15.

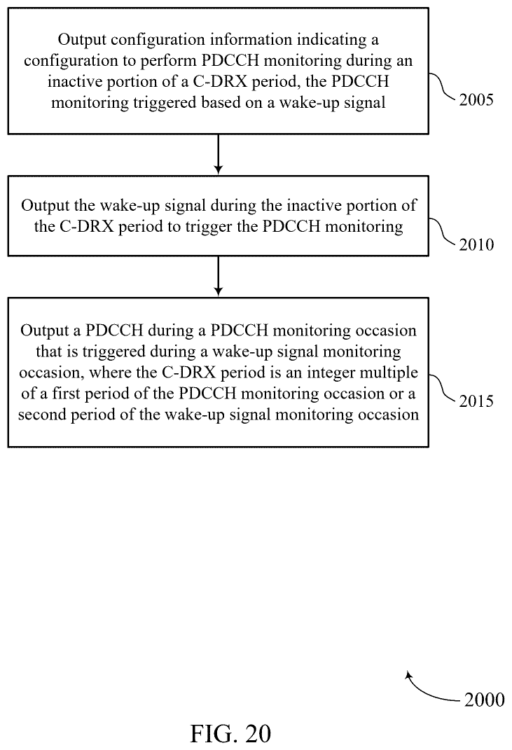

FIG. 20 shows a flowchart illustrating a method 2000 that supports configurations for wake-up signals with discontinuous reception in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include outputting configuration information indicating a configuration to perform PDCCH monitoring during an inactive portion of a C-DRX period, the PDCCH monitoring triggered based on a wake-up signal. The operations of 2005 may be performed in accordance with examples as disclosed herein. In some examples, aspects of the operations of 2005 may be performed by a configuration manager 1525 as described with reference to FIG. 15.

At 2010, the method may include outputting the wake-up signal during the inactive portion of the C-DRX period to trigger the PDCCH monitoring. The operations of 2010 may be performed in accordance with examples as disclosed herein. In some examples, aspects of the operations of 2010 may be performed by a wake-up signal manager 1535 as described with reference to FIG. 15.

At 2015, the method may include outputting a PDCCH during a PDCCH monitoring occasion that is triggered during a wake-up signal monitoring occasion, where the C-DRX period is an integer multiple of a first period of the PDCCH monitoring occasion or a second period of the wake-up signal monitoring occasion. The operations of 2015 may be performed in accordance with examples as disclosed herein. In some examples, aspects of the operations of 2015 may be performed by a control manager 1530 as described with reference to FIG. 15.

The following provides an overview of aspects of the present disclosure:
Aspect 1: A method for wireless communications at a UE, comprising: receiving, from a network entity, configuration information indicating a configuration of the UE to perform PDCCH monitoring during an inactive portion of a C-DRX period, the PDCCH monitoring triggered based at least in part on a wake-up signal received via a first radio component of the UE that consumes less operating power than a second radio component of the UE; and receiving, from the network entity, a PDCCH during a PDCCH monitoring occasion that is triggered during a wake-up signal monitoring occasion, wherein the C-DRX period is an integer multiple of a first period of the PDCCH monitoring occasion or a second period of the wake-up signal monitoring occasion.
Aspect 2: The method of aspect 1, further comprising: receiving, via the first radio component, the wake-up signal during the inactive portion of the C-DRX period, the PDCCH monitoring triggered based at least in part on the wake-up signal received during the inactive portion of the C-DRX period.
Aspect 3: The method of any of aspects 1 through 2, further comprising: receiving, from the network entity, an indication of a periodicity and a first offset, wherein the wake-up signal monitoring occasion is based at least in part on the periodicity and the first offset, and wherein the PDCCH monitoring occasion is based at least in part on the wake-up signal monitoring occasion.
Aspect 4: The method of aspect 3, wherein a start of the PDCCH monitoring occasion is based at least in part on a second offset from an end of the wake-up signal that is transmitted during the wake-up signal monitoring occasion, from an end of a slot in which the wake-up signal is transmitted, or from an end of a window for multiple wake-up signals.
Aspect 5: The method of any of aspects 1 through 2, further comprising: receiving, from the network entity, an indication of a periodicity and a first offset, wherein the PDCCH monitoring occasion is based at least in part on the periodicity and the first offset, and wherein the wake-up signal monitoring occasion is based at least in part on the PDCCH monitoring occasion.
Aspect 6: The method of aspect 5, further comprising: receiving, from the network entity, an indication of a second offset, wherein the wake-up signal monitoring occasion is based at least in part on the second offset from the PDCCH monitoring occasion.
Aspect 7: The method of any of aspects 1 through 6, wherein a first subframe offset for an active portion of the C-DRX period is equal to a second subframe offset for the PDCCH monitoring occasion or a first slot offset for the active portion of the C-DRX period is equal to a second slot offset for the PDCCH monitoring occasion.
Aspect 8: The method of any of aspects 1 through 7, wherein a first subframe offset for an active portion of the C-DRX period is equal to a second subframe offset for the wake-up signal monitoring occasion or a first slot offset for the active portion of the C-DRX period is equal to a second slot offset for the wake-up signal monitoring occasion.
Aspect 9: The method of any of aspects 1 through 8, further comprising: receiving, from the network entity, an indication of the integer multiple, wherein the first period of the PDCCH monitoring occasion or the second period of the wake-up signal monitoring occasion is based at least in part on the integer multiple.
Aspect 10: The method of any of aspects 1 through 9, wherein the first period of the PDCCH monitoring occasion or the second period of the wake-up signal monitoring occasion is based at least in part on dividing the C-DRX period by the integer multiple.
Aspect 11: A method for wireless communications at a network entity, comprising: outputting configuration information indicating a configuration to perform PDCCH monitoring during an inactive portion of a C-DRX period, the PDCCH monitoring triggered based at least in part on a wake-up signal; and outputting a PDCCH during a PDCCH monitoring occasion that is triggered during a wake-up signal monitoring occasion, wherein the C-DRX period is an integer multiple of a first period of the PDCCH monitoring occasion or a second period of the wake-up signal monitoring occasion.
Aspect 12: The method of aspect 11, further comprising: outputting the wake-up signal during the inactive portion of the C-DRX period to trigger the PDCCH monitoring.
Aspect 13: The method of any of aspects 11 through 12, further comprising: outputting an indication of a periodicity and a first offset, wherein the wake-up signal monitoring occasion is based at least in part on the periodicity and the first offset, and wherein the PDCCH monitoring occasion is based at least in part on the wake-up signal monitoring occasion.
Aspect 14: The method of aspect 13, wherein a start of the PDCCH monitoring occasion is based at least in part on a second offset from an end of the wake-up signal that is transmitted during the wake-up signal monitoring occasion, from an end of a slot in which the wake-up signal is transmitted, or from an end of a window for multiple wake-up signals.
Aspect 15: The method of any of aspects 11 through 14, further comprising: outputting an indication of a periodicity and a first offset, wherein the PDCCH monitoring occasion is based at least in part on the periodicity and the first offset, and wherein the wake-up signal monitoring occasion is based at least in part on the PDCCH monitoring occasion.
Aspect 16: The method of aspect 15, further comprising: outputting an indication of a second offset, wherein the wake-up signal monitoring occasion is based at least in part on the second offset from the PDCCH monitoring occasion.
Aspect 17: The method of any of aspects 11 through 12, wherein a first subframe offset for an active portion of the C-DRX period is equal to a second subframe offset for the PDCCH monitoring occasion or a first slot offset for the active portion of the C-DRX period is equal to a second slot offset for the PDCCH monitoring occasion.
Aspect 18: The method of any of aspects 11 through 17, wherein a first subframe offset for an active portion of the C-DRX period is equal to a second subframe offset for the wake-up signal monitoring occasion or a first slot offset for the active portion of the C-DRX period is equal to a second slot offset for the wake-up signal monitoring occasion.
Aspect 19: The method of any of aspects 11 through 18, further comprising: outputting an indication of the integer multiple, wherein the first period of the PDCCH monitoring occasion or the second period of the wake-up signal monitoring occasion is based at least in part on the integer multiple.
Aspect 20: A UE comprising one or more memories storing processor-executable code, and one or more processors coupled with the one or more memories and individually or collectively operable to execute the code to cause the UE to perform a method of any of aspects 1 through 10.
Aspect 21: A UE comprising at least one means for performing a method of any of aspects 1 through 10.
Aspect 22: A non-transitory computer-readable medium storing code the code comprising instructions executable by one or more processors to perform a method of any of aspects 1 through 10.
Aspect 23: A network entity comprising one or more memories storing processor-executable code, and one or more processors coupled with the one or more memories and individually or collectively operable to execute the code to cause the network entity to perform a method of any of aspects 11 through 19.
Aspect 24: A network entity comprising at least one means for performing a method of any of aspects 11 through 19.
Aspect 25: A non-transitory computer-readable medium storing code the code comprising instructions executable by one or more processors to perform a method of any of aspects 11 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, configuration information indicating a configuration of the UE to perform physical downlink control channel (PDCCH) monitoring during an inactive portion of a connected mode discontinuous reception period, the PDCCH monitoring triggered based at least in part on a wake-up signal received via a first radio component of the UE that consumes less operating power than a second radio component of the UE; and
receive, from the network entity, a PDCCH during a PDCCH monitoring occasion that is triggered during a wake-up signal monitoring occasion, wherein the connected mode discontinuous reception period is an integer multiple of a first period of the PDCCH monitoring occasion or a second period of the wake-up signal monitoring occasion.

2. The UE of claim 1, wherein the one or more processors are individually or collectively further operable to execute the code to cause the UE to:
receive, via the first radio component, the wake-up signal during the inactive portion of the connected mode discontinuous reception period, the PDCCH monitoring triggered based at least in part on the wake-up signal received during the inactive portion of the connected mode discontinuous reception period.

3. The UE of claim 1, wherein the one or more processors are individually or collectively further operable to execute the code to cause the UE to:
receive, from the network entity, an indication of a periodicity and a first offset, wherein the wake-up signal monitoring occasion is based at least in part on the periodicity and the first offset, and wherein the PDCCH monitoring occasion is based at least in part on the wake-up signal monitoring occasion.

4. The UE of claim 3, wherein a start of the PDCCH monitoring occasion is based at least in part on a second offset from an end of the wake-up signal that is transmitted during the wake-up signal monitoring occasion, from an end of a slot in which the wake-up signal is transmitted, or from an end of a window for multiple wake-up signals.

5. The UE of claim 1, wherein the one or more processors are individually or collectively further operable to execute the code to cause the UE to:
receive, from the network entity, an indication of a periodicity and a first offset, wherein the PDCCH monitoring occasion is based at least in part on the periodicity and the first offset, and wherein the wake-up signal monitoring occasion is based at least in part on the PDCCH monitoring occasion.

6. The UE of claim 5, wherein the one or more processors are individually or collectively further operable to execute the code to cause the UE to:
receive, from the network entity, an indication of a second offset, wherein the wake-up signal monitoring occasion is based at least in part on the second offset from the PDCCH monitoring occasion.

7. The UE of claim 1, wherein a first subframe offset for an active portion of the connected mode discontinuous reception period is equal to a second subframe offset for the PDCCH monitoring occasion or a first slot offset for the active portion of the connected mode discontinuous reception period is equal to a second slot offset for the PDCCH monitoring occasion.

8. The UE of claim 1, wherein a first subframe offset for an active portion of the connected mode discontinuous reception period is equal to a second subframe offset for the wake-up signal monitoring occasion or a first slot offset for the active portion of the connected mode discontinuous reception period is equal to a second slot offset for the wake-up signal monitoring occasion.

9. The UE of claim 1, wherein the one or more processors are individually or collectively further operable to execute the code to cause the UE to:
receive, from the network entity, an indication of the integer multiple, wherein the first period of the PDCCH monitoring occasion or the second period of the wake-up signal monitoring occasion is based at least in part on the integer multiple.

10. The UE of claim 1, wherein the first period of the PDCCH monitoring occasion or the second period of the wake-up signal monitoring occasion is based at least in part on dividing the connected mode discontinuous reception period by the integer multiple.

11. A network entity, comprising:
one or more memories storing processor-executable code; and
one or more processors coupled with the one or more memories and individually or collectively operable to execute the code to cause the network entity to:
output configuration information indicating a configuration to perform physical downlink control channel (PDCCH) monitoring during an inactive portion of a connected mode discontinuous reception period, the PDCCH monitoring triggered based at least in part on a wake-up signal; and
output a PDCCH during a PDCCH monitoring occasion that is triggered during a wake-up signal monitoring occasion, wherein the connected mode discontinuous reception period is an integer multiple of a first period of the PDCCH monitoring occasion or a second period of the wake-up signal monitoring occasion.

12. The network entity of claim 11, wherein the one or more processors are individually or collectively further operable to execute the code to cause the network entity to:
output the wake-up signal during the inactive portion of the connected mode discontinuous reception period to trigger the PDCCH monitoring.

13. The network entity of claim 11, wherein the one or more processors are individually or collectively further operable to execute the code to cause the network entity to:
output an indication of a periodicity and a first offset, wherein the wake-up signal monitoring occasion is based at least in part on the periodicity and the first offset, and wherein the PDCCH monitoring occasion is based at least in part on the wake-up signal monitoring occasion.

14. The network entity of claim 13, wherein a start of the PDCCH monitoring occasion is based at least in part on a second offset from an end of the wake-up signal that is transmitted during the wake-up signal monitoring occasion, from an end of a slot in which the wake-up signal is transmitted, or from an end of a window for multiple wake-up signals.

15. The network entity of claim 11, wherein the one or more processors are individually or collectively further operable to execute the code to cause the network entity to:
output an indication of a periodicity and a first offset, wherein the PDCCH monitoring occasion is based at least in part on the periodicity and the first offset, and wherein the wake-up signal monitoring occasion is based at least in part on the PDCCH monitoring occasion.

16. The network entity of claim 15, wherein the one or more processors are individually or collectively further operable to execute the code to cause the network entity to:
output an indication of a second offset, wherein the wake-up signal monitoring occasion is based at least in part on the second offset from the PDCCH monitoring occasion.

17. The network entity of claim 11, wherein a first subframe offset for an active portion of the connected mode discontinuous reception period is equal to a second subframe offset for the PDCCH monitoring occasion or a first slot offset for the active portion of the connected mode discontinuous reception period is equal to a second slot offset for the PDCCH monitoring occasion.

18. The network entity of claim 11, wherein a first subframe offset for an active portion of the connected mode discontinuous reception period is equal to a second subframe offset for the wake-up signal monitoring occasion or a first slot offset for the active portion of the connected mode discontinuous reception period is equal to a second slot offset for the wake-up signal monitoring occasion.

19. The network entity of claim 11, wherein the one or more processors are individually or collectively further operable to execute the code to cause the network entity to:
output an indication of the integer multiple, wherein the first period of the PDCCH monitoring occasion or the second period of the wake-up signal monitoring occasion is based at least in part on the integer multiple.

20. A method for wireless communications at a user equipment (UE), comprising:
receiving, from a network entity, configuration information indicating a configuration of the UE to perform physical downlink control channel (PDCCH) monitoring during an inactive portion of a connected mode discontinuous reception period, the PDCCH monitoring triggered based at least in part on a wake-up signal received via a first radio component of the UE that consumes less operating power than a second radio component of the UE; and
receiving, from the network entity, a PDCCH during a PDCCH monitoring occasion that is triggered during a wake-up signal monitoring occasion, wherein the connected mode discontinuous reception period is an integer multiple of a first period of the PDCCH monitoring occasion or a second period of the wake-up signal monitoring occasion.
